(19) United States
(12) Patent Application Publication
(10) Pub. No.: US 2009/0184924 A1
(43) Pub. Date: Jul. 23, 2009

(54) Projection Device, Computer Readable Recording Medium Which Records Program, Projection Method and Projection System

(75) Inventor: Katsura Uchida, Nagoya-shi (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: Brother Kogyo Kabushiki Kaisha, Nagoya-shi (JP)

(21) Appl. No.: 12/414,449

(22) Filed: Mar. 30, 2009

Related U.S. Application Data
(63) Continuation-in-part of application No. PCT/JP2007/068827, filed on Sep. 27, 2007.

(30) Foreign Application Priority Data
Sep. 29, 2006 (JP) 2006-270131
Nov. 15, 2006 (JP) 2006-308843

(51) Int. Cl. G09G 5/08; H04N 5/74; H04N 9/31

(52) U.S. Cl. 345/157; 348/744; 348/E05.143; 348/E09.025

(57) ABSTRACT

A projection device in which a displayed pointer image of an input device can be shifted by a plurality of users is provided. A projection device includes a wireless transmitting/receiving unit for receiving command signals of mouses connected with a plurality of computer units from the respective computer units; a pointer image generating unit (information processing unit) for generating pointer images of the mouses; a pointer image position setting unit (information processing unit) for setting a pointer image position based on the received command signals of the mouses; and a projection unit for projecting an image including the pointer image at least at the set position.

### CROSS-REFERENCE TO RELATED APPLICATIONS

The present application is a Continuation-in-Part of International Application PCT/JP2007/068827 filed on Sep. 27, 2007, which claims the benefits of Japanese Patent Application No. 2006-270131 filed on Sep. 29, 2006 and Japanese Patent Application No. 2006-308843 filed on Nov. 15, 2006.

### BACKGROUND

1. Field

The present invention relates to a projection device which displays an image, and more particularly to a projection device which allows a plurality of users to perform operations with respect to an application program by shifting a pointer image of a mouse displayed by a display device.

2. Description of the Related Art

Recently, there has been proposed a projection device which allows inputting of a plurality of image information therein and collectively displays such inputted images within one image.

For example, there has been known a monitor control system having a multi-screen display function which includes a plurality of projector displays, a plurality of computers which individually perform image display controls of the respective displays, wherein each computer is connected with a process controller or the like via network connection. Such a monitor control system further mounts a remote mouse server process on one computer, and a mouse and a keyboard are connected with one computer so that information on mouse cursor shifting, button events and key board inputting is transmitted to one computer (see JP-A-10-39921 (patent document 1)).

According to the monitor control system described in patent document 1, although the monitor control system is configured to include one mouse and the keyboard, a system allows a user to perform an operation such as the shifting of a pointer with respect to a selected arbitrary screen out of the plurality of screens which displays a screen. Further, the system allows the user to display one mouse cursor on respective screens, and the system allows the user to shift the mouse cursor as if the plurality of screens is one screen.

### SUMMARY

In the monitor control system described in patent document 1, the shifting of the mouse cursor, inputting of characters and the like can be performed using information on the mouse or the keyboard received from a plurality of computers. However, there arises a drawback that a dedicated computer for operating the mouse and the keyboard is necessary. Further, according to the invention described in patent document 1, the number of users who operate the mouse and the keyboard is limited to one and hence, there arises a drawback that a plurality of users cannot shift a pointer image by operating the mouse.

According to a first aspect of the present invention, there is provided a projection device which includes: a receiving unit which is configured to receive command signals of input devices which are connected with a plurality of computer devices from said plurality of respective computer devices; a pointer image forming unit which is configured to form pointer images of the input devices; a pointer image position setting unit which is configured to set pointer image positions based on the command signals of the input devices; and a projection unit which is configured to project an image including at least the pointer images at the pointer image positions set by the pointer image position setting unit.

According to a second aspect of the present invention, there is provided a computer-readable recording medium recording a program executed by an information processing unit of a projection device which includes: a receiving unit which is configured to receive command signals of input devices from a plurality of computer devices; a video signal receiving unit which is configured to receive video signals from the plurality of computer devices; an image arranging unit which is configured to synthesize and arrange one or a plurality of images within a region of one image; an image region identification information generating unit which is configured to generate image region identification information in which the region of the image and computer device identification information are associated with each other; a pointer image forming unit which is configured to form a pointer image arranged within the region of said one image; a pointer image position setting unit which is configured to set a pointer image position based on a command signal of the input device; a projection unit which is configured to project said one or plurality of images which are synthesized and arranged at a predetermined position within said one image and the pointer image; a computer device specifying unit which is configured to specify the computer device which outputs a predetermined video signal; a transmitting unit which is configured to transmit a corresponding command which corresponds to a projection position of the set pointer image for the specified computer device; and the information processing unit which is capable of controlling the receiving unit, the video signal receiving unit, the image arranging unit, the image region identification information generating unit, the pointer image forming unit, the pointer image position setting unit, the projection unit, the computer device specifying unit, and the transmitting unit, wherein the program is executed by the information processing unit such that: the receiving unit performs a function of receiving the command signals of the input devices which are connected with the plurality of computer devices from the plurality of computer devices, the video signal receiving unit performs a function of receiving said one or plurality of video signals from said one or plurality of computer devices, the image arranging unit performs a function of synthesizing and arranging said one or plurality of video signals generated based on the received one or plurality of video signals, the image region identification information generating unit performs a function of generating computer device identification information which specifies computer device which outputs the image, and image region identification information which associates said one region in which one or a plurality of images are arranged and the computer device identification information with each other, the pointer image forming unit performs a function of forming the pointer image which is arranged within the region of said one image, the pointer image position setting unit performs a function of setting a position of the pointer image based on the received command signal, the projection unit performs a function of projecting said one or plurality of images which are synthesized and arranged within the region of one image, and the pointer image which is set at the position, the computer device identifying unit performs a function of specifying the computer devices which output an image pointed out by the pointer image from the projection position of the pointer image set at the position and the image region identification information, and the transmitting unit performs a function of transmitting specified command signal corresponding to the set projection position of the pointer image to the specified computer device based on the received command signal of the input device.

According to a third aspect of the present invention, there is provided a projection method of an image using a projection device which includes: a receiving unit which is configured to receive command signals of input devices from a plurality of computer devices; a video signal receiving unit which is configured to receive video signals from the plurality of computer devices; an image arranging unit which is configured to synthesize and arrange one or a plurality of images within a region of one image; an image region identification information generating unit which is configured to generate image region identification information in which the region of the image and computer device identification information are associated with each other; a pointer image forming unit which is configured to form a pointer image arranged within the region of said one image; a pointer image position setting unit which is configured to set a pointer image position based on a command signal of the input device; a projection unit which is configured to project said one or plurality of images which are synthesized and arranged at a predetermined position within said region of one image and the pointer image; a computer device specifying unit which is configured to specify the computer device which outputs a predetermined video signal; a transmitting unit which is configured to transmit a corresponding command which corresponds to a projection position of the set pointer image for the specified computer device, the projection method of an image comprising the steps of: receiving the command signals of the input devices which are connected with the plurality of computer devices from the plurality of computer devices; receiving said one or plurality of video signals from said one or plurality of computer devices; synthesizing and arranging said one or plurality of video signals generated based on received one or plurality of video signals within a region of one image; generating computer device identification information which specifies computer device which outputs the image, and image region identification information which associates said one region in which one or a plurality of images are arranged and the computer device identification information with each other; forming the pointer image which is arranged within the region of said one image; setting a position of the pointer image based on the received command signal; projecting said one or plurality of images which are synthesized and arranged within the region of one image, and the pointer image which is set at the position, specifying the computer device which outputs an image which is pointed out by the pointer image from the projection position of the pointer image set at the position and the image region identification information; and transmitting a specified command signal corresponding to the set projection position of the pointer image to the specified computer device based on the received command signal of the input device.

According to a fourth aspect of the present invention, there is provided a projection system including: a plurality of computer devices with which input devices are connected; and a projection device which is configured to receive video signals from the plurality of computer devices and command signals of the input devices and is configured to project an image and a pointer image within a region of one image, wherein each computer device includes: a) a command signal transmitting unit which is configured to output the command signal of the input device to the projection device; b) a video signal transmitting unit which is configured to output the video signal of the image to be displayed based on an application program to the projection device; c) a command signal receiving unit which is configured to receive a specified command signal generated based on the command signal of the input device from the projection device; and d) a shift signal transferring unit which is configured to transfer the received specified command signal to the application program; and a projection device includes: a) a receiving unit which is configured to receive command signals of input devices which are connected with a plurality of computer devices from the plurality of respective computer devices; b) a video signal receiving unit which is configured to receive one or a plurality of video signals from one or the plurality of computer devices; c) an image arranging unit which is configured to synthesize and arrange one or a plurality of images formed based on the received one or plurality of video signals within a region of one image; d) an image region identification information forming unit which is configured to generate computer device identification information which specifies the computer device which outputs the image, and image region identification information which associates said one region in which one or a plurality of images are arranged and the computer device identification information with each other; e) a pointer image forming unit which is configured to form pointer images which are arranged within the region of said one image; f) a pointer image position setting unit which is configured to set a position of the pointer image based on the received command signal; g) a projection unit which is configured to project said one or plurality of images which are synthesized and arranged within the region of one image, and the pointer image which is set at the position; h) a computer device specifying unit which is configured to specify the computer device which outputs an image pointed out by the pointer image from the projection position of the pointer image set at the position and the image region identification information; and i) a transmitting unit which is configured to transmit a specified command signal corresponding to the set projection position of the pointer image to the specified computer device based on the received command signal of the input device.

### BRIEF DESCRIPTION OF THE DRAWINGS

FIG. 1 is a view showing the constitution of a projection system including a projection device according to an embodiment of the present invention;

FIG. 2 is a block diagram of a signal processing system of a computer device;

FIG. 3 is a block diagram of a signal processing system of a projection device;

FIG. 4 is a flowchart showing projection image forming processing which is executed by the projection device;

FIG. 5 is a table showing a mode of image region identification information in which regions of four images and computer device identification information which identifies the computer devices which output the images are associated with each other;

FIG. 6A and FIG. 6B are flowcharts showing operation event transmission processing which an information processing unit of the computer device executes and operation event processing which an information processing unit of the projection device executes;

FIG. 7 is a table showing a structural example of event information which the computer device transmits;

FIG. 8 is a table showing a structural example of commands which the projection device transmits to the computer devices;

FIG. 9A and FIG. 9B are flowcharts showing a mode of operation event processing including filter processing;

FIG. 10 is a table showing an example of a block command list;

FIG. 11A to FIG. 11C are flowcharts of processing for projecting and shifting a plurality of pointer images which differ in display color and shape for the plurality of respective computer devices;

FIG. 12 is a view showing another constitution of the projection system which includes the projection device according to the embodiment of the present invention;

FIG. 13 is a view showing a structural example of a display color table of pointer images;

FIG. 14 is a view showing a structural example of a shape table of the pointer images;

FIG. 15A and FIG. 15B are flowcharts of processing capable of changing over a projection mode between a mode in which a dedicated pointer image is projected and a mode in which a commonly-shared pointer image is projected for the plurality of respective computer devices;

FIG. 16A and FIG. 16B are sub routine of pointer image separating/merging processing which an information processing unit of a projection device executes;

FIG. 17 is a table showing a mode of the pointer image list;

FIG. 18 is a view showing a state in which red-arrowed pointer information dedicated to PC3 is registered in the pointer image list shown in FIG. 17;

FIG. 19 is a view showing a state in which the dedicated pointer image is separated from the common pointer image;

FIG. 20A and FIG. 20B are flowcharts of operation event transmitting processing which the information processing unit of the computer device executes and the operation event processing which the information processing unit of the projection device executes;

FIG. 21 is a table showing a structural example of event information which the computer device transmits;

FIG. 22A and FIG. 22B are flowcharts of processing of projection and shifting of a plurality of pointer images which differ in display color or shape for the plurality of respective computer devices;

FIG. 23A and FIG. 23B are flowcharts of processing capable of changing over a projection mode between a mode in which a dedicated pointer image is projected and a mode in which a commonly-shared pointer image is projected for a plurality of respective computer devices;

FIG. 24 is a table showing an example of a pointer image list; and

FIG. 25 is a table showing a state in which red-arrowed pointer information dedicated to PC3 is registered in the pointer image list shown in FIG. 24.

### DETAILED DESCRIPTION

Embodiments of the present invention are explained hereinafter in conjunction with attached drawings.

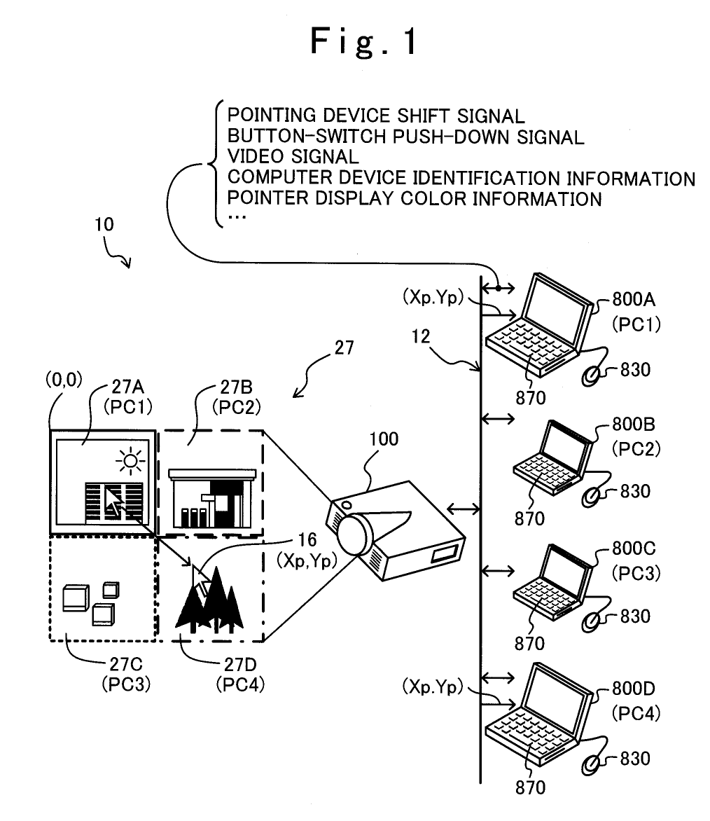

FIG. 1 is a view showing the constitution of a projection system including a projection device according to the embodiment of the present invention.

As shown in FIG. 1, the projection system 10 includes the projection device 100 which projects a projection image 27 and performs transmission/reception of various information with a plurality of computer devices 800A, 800B, 800C, 800D via a communication line 12.

A mouse 830 which constitutes one form of input equipment is connected to each computer device 800A, 800B, 800C, 800D. When a user operates the mouse 830, a command signal of the input equipment acquired by such an operation is outputted to the computer device 800A, 800B, 800C, 800D. The explanation is made hereinafter by using a pointing device which includes the mouse 830 as one example of the input equipment, and a shift signal or a push-down signal outputted from the pointing device as one example of a command signal.

In a usual using state in which the projection system 10 is used in general, when the computer device 800A, 800B, 800C, 800D acquires the shift signal or the button push-down signal of the pointing device, the computer device 800A, 800B, 800C, 800D executes processing of shifting mouse cursors displayed on displays based on the acquired shift signal of the pointing device or executes processing of the transfer of display position information on the mouse cursor or a button push-down signal to an application program.

However, in the embodiment of the present invention, the projection system 10 has a function of transmitting the shift signal of the pointing device and the button push-down signal to the projection device 100 via a communication line 12 without executing processing of shifting of the mouse cursor and processing of the transfer of the display position information on the mouse cursor and the button push-down signal to an application program.

Further, in a usual using state in which the projection system 10 is used in general, when the computer device 800A, 800B, 800C, 800D acquires the button push-down signal of an input unit 870 such as a keyboard, the computer device 800A, 800B, 800C, 800D executes processing of displaying of characters or the like corresponding to the acquired button push-down signal of the input unit 870 or the processing of the transfer of the button push-down signal of the input unit 870 to the application program.

However, in the embodiment of the present invention, the projection system 10 has a function of transmitting the button push-down signal of the input unit 870 to the projection device 100 via a communication line 12 without executing processing of displaying of characters and the like corresponding to the button push-down signal of the input unit 870 and processing of the transfer of the button push-down signal of the input unit 870 to the application program.

Further, the computer device 800A, 800B, 800C, 800D has a function of receiving the shift signal for shifting the pointer image 16, the button push-down signal or the like from the projection device 100 and of transferring the shift signal and the button push-down signal to the application program.

In the embodiment shown in FIG. 1, by operating the mouse 830 which is connected with the computer device 800A, 800B, 800C, 800D, it is possible to shift the pointer image 16 of the mouse which the projection device 100 displays independently.

Further, the projection device 100 specifies the computer device 800A which transmits the video signal of the image from a region of the image which the pointer image 16 of the mouse 830 points out, and the projection device 100 transmits the shift signal of the mouse 830 or the button push-down signal to the specified computer device 800A.

Due to such constitution, it is possible to inform the positional information on the pointer image 16 of the mouse 830 displayed on a projection device 100 side to the computer device 800A which outputs an image that the pointer image 16 of the mouse 830 points out. Accordingly, the users who operate a plurality of computer devices 800A, 800B, 800C, 800D can perform a designation operation of a button switch, a dialog box or window region displayed in a projected image 27 or the like.

Further, the computer device 800A, 800B, 800C, 800D has a function of transmitting a video signal of an image which an application program operated by the computer device 800A, 800B, 800C, 800D displays to the projection device 100 via the communication line 12 or a dedicated video signal line.

The projection device 100 has a function of receiving the video signal from the computer device 800A, 800B, 800C, 800D connected with the projection device 100 via the communication line 12 or the like and of displaying the projection image 27 based on the video signal on a projection screen. In this embodiment, the projection device 100 receives a video signal which is received from one computer device 800A (PC1) and displays one projection image 27A on the projection screen.

Further, the projection device 100 has a function of receiving the shift signal of the pointing device or the button push-down signal from the computer device 800A, 800B, 800C, 800D which is connected with the projection device 100 via the communication line 12, for example, the computer device 800C and of projecting and shifting the pointer image 16 within the projection image 27 based on the received shift signal of the pointing device.

Further, for example, when the projection device 100 receives shift signals of a plurality of pointing devices from the plurality of computer devices 800A, 800B, 800C, 800D, the above-mentioned received operation signals of the pointing devices are added and one pointer image 16 is shifted thus allowing a plurality of users to shift the pointer image 16.

In the embodiment shown in FIG. 1, as one mode of the pointing device which constitutes the input device, the mouse 830 is used. However, the input device of the present invention is not limited to the mouse 830, and other input unit such as a track ball, a touch pad, a tablet, other pointing device, a keyboard and the like can be used. Further, a command signal from the input device is not limited to a shift signal or a push-down signal from the above-mentioned pointing device, and may be a signal which also contains a push-down signal of a keyboard. A wireless communication unit may be used without using the communication line 12.

Further, the projection device 100 executes processing in which the projection device 100 specifies the computer device 800A which outputs the projection image 27A pointed out by the pointer image 16, and transmits a shift signal for shifting the pointer image 16 in the projection image 27A with respect to the specified computer device 800A as a specified command signal. Accordingly, in the computer device 800A which receives the specified command signal, a cursor or the like displayed on the computer device 800A is shifted based on the specified command signal. Hereinafter, the explanation is made with respect to a case in which a shift signal or a button switch push-down signal is used as the specified command signal to be transmitted to the computer device specified by the projection device 100 as the specified command signal.

Due to such constitution, it is possible to inform the positional information of the pointer image 16 of the mouse 830 which the projection device 100 displays to the computer device 800A which outputs the projection image 27A which the pointer image 16 of the mouse 830 points out, for example and hence, users who operate a plurality of computer devices 800A, 800B, 800C, 800D can respectively perform a designation operation of a button switch, a dialog box, a window region displayed on the projection image 27 or the like.

Further, the projection device 100 executes the following processing. That is, the projection device 100 receives the shift signal or the button switch push-down signal of the pointing device from the computer device 800C, for example, and shifts the pointer image 16 based on the received shift signal of the pointing device and, at the same time, specifies the computer device 800A which outputs the projection image 27, and transmits the shift signal indicative of the shifting of the pointer image 16 on the projection image 27A to the computer device 800A as the specified command signal.

Further, by allowing the specified command signal to contain the button switch push-down signal and the like together with the shift signal, the user of the computer device 800C can perform the operation of the computer device 800A. As a result, the user who is operating one computer device while watching an image projected by the projection device can operate an image outputted from another computer device and hence, the user can perform a common operation in which, in performing the correction of an image projected by the projection device or the like, the user of each computer device can directly perform the correction or the like without always instructing the correction or the like to the user of the computer which projects the image.

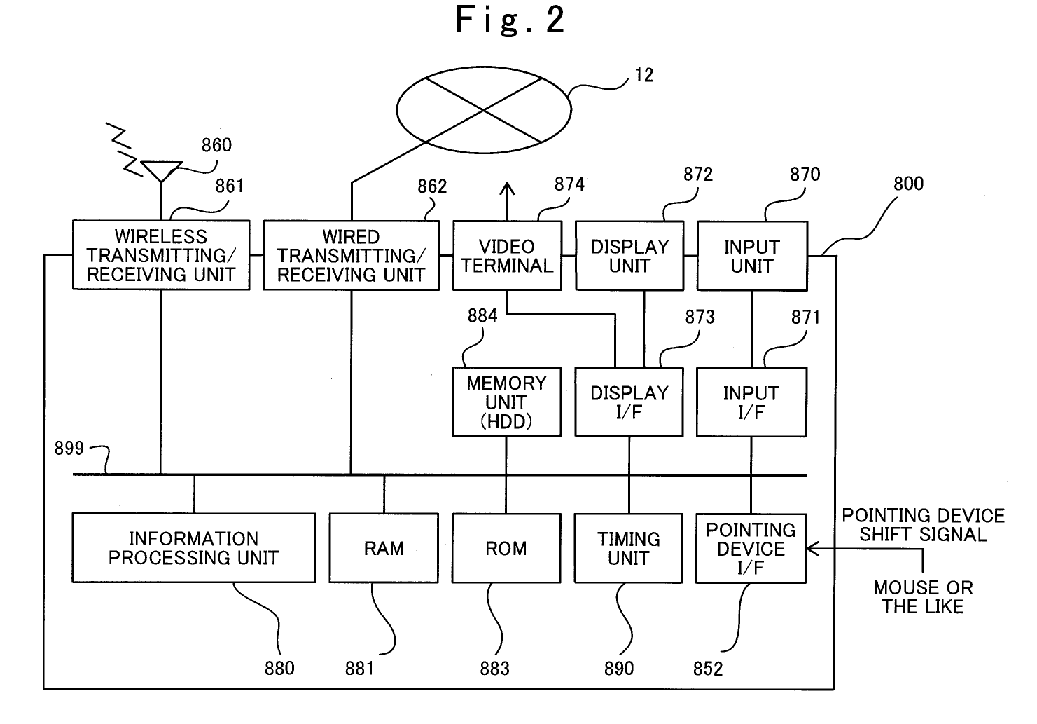

Next, the constitution of the computer devices 800A and 800B is explained in conjunction with FIG. 2.

FIG. 2 shows a signal processing system of the computer device 800.

As shown in FIG. 2, the computer device 800 includes a pointing device interface 852, an input unit 870 and an input interface 871. Here, the pointing device interface 852 is provided for inputting a shift signal of the pointing device such as an X-direction shift signal, a Y-direction shift signal, a scroll quantity or the like, and button-switch push-down signals of various button switches mounted on the pointing device when the mouse 830 which is connected with the computer device 800 is operated. The input unit 870 is constituted of a keyboard or the like which inputs various information including characters, control instructions and the like due to an operation of a user. The input interface 871 receives button-switch push-down signals outputted from the input unit 870 when the button switch which is mounted on the input unit 870 are pushed down, temporarily stores the button-switch push-down signals, and outputs the button push-down signals in response to a request from the information processing unit 880 via a bus 899.

Further, the computer device 800 includes a wireless transmitting/receiving unit 861 (including a function of a command signal transmitting unit, a function of a command signal receiving unit, and a function of a video signal transmitting unit), and a wired transmitting/receiving unit 862 (including a function of a command signal transmitting unit, a function of a command signal receiving unit, and a function of a video signal transmitting unit). Here, the wireless transmitting/receiving unit 861 executes transmitting/receiving processing with other image display device such as the projection device 100 by wireless communication by way of an antenna 860 with respect to various information such as a shift signal of the pointing device, a button-switch push-down signal which is generated when the pointing device or the input unit 870 is operated, computer device identification information, pointer display color information, pointer shape information, information which makes a shift signal for shifting the pointer image 16 and a size of an image associated with each other and a video signal all of which are carried by a carrier wave. The wired transmitting/receiving unit 862 executes transmitting/receiving processing with other image display devices such as the projection device 100 via the wired communication line 12 with respect to the above-mentioned various information carried on a carrier wave.

Here, the computer device identification information is intrinsic identification information which identifies the computer device 800 from other communication devices. Further, the pointer display color information is information which specifies display color of the pointer image 16 which the projection device 100 projects, and the pointer shape information is information which specifies a shape of the pointer image 16 which the projection device 100 projects. Further, the command signal transmitting unit included in the wireless transmitting/receiving unit 861 or the wired transmitting/receiving unit 862 contains a command transmitting program. By starting and executing the program at the time of transmitting the command signal, the command signal is transmitted to the projection device 100 together with the video signal or the like via an interface which is included in the wireless transmitting/receiving unit 861 or the wired transmitting/receiving unit 862.

It is needless to say that a command transmitting circuit which is constituted of a dedicated logic circuit may be used in place of the command transmitting program.

Further, as the interface which is included in the wired transmitting/receiving unit 862, it is possible to use a LAN, a USB, an IEEE 1394, an RS 232, an RS 422 or other communication interfaces. Further, as the interface which is included in the wireless transmitting/receiving unit 861, it is possible to use a so-called wireless LAN or Bluetooth (registered trade mark) or other wireless interfaces which are stipulated in the IEEE 802.

Further, the computer device 800 also includes a display interface 873 which acquires image data whose display is instructed by an application program operated by the computer device 800A, 800B, 800C, 800D via a bus 899, converts such image data into video signals, and outputs the video signals to the display unit 872. Further, the display interface 873 is configured to be capable of outputting the video signal to an external device such as the projection device 100 via a video terminal 874 (including a function of video signal transmitting unit).

Further, the computer device 800 includes an information processing unit 880 which executes an operating system or an application program for controlling hardware of the computer device 800, executes processing of the instruction of the transmission or the like of a shift signal of the pointing device, a button-switch push-down signal, computer device identification information, pointer display color information, pointer shape information or video signal which is generated when the pointing device or the input unit 870 is operated to respective peripheral circuits, and executes processing of controlling the whole computer device 800.

Further, the computer device 800 includes a RAM 881 which forms a work region at the time of executing various programs, a ROM 883 which can store computer device identification information, pointer display color information, pointer shape information, other various information and a program, a memory unit 884 such as a hard disk which can store an operating system, various application programs, computer device identification information, pointer display color information, pointer shape information, and other various information and a timer unit 890 which counts time. Here, the RAM 881, the ROM 883, the memory unit 884 or the like can store button-switch push-down signals of a predetermined keyboard or the combination of these push-down signals as mask data.

The information processing unit 880 of the computer device 800 and peripheral circuits of the information processing unit 880 are connected by a bus 899 so as to enable high-speed transmission of information among them. In accordance with an instruction of the processing program operated by the information processing unit 880, the information processing unit 880 can control the peripheral circuits. Here, the processing program which is executed by the information processing unit 880 may be, for example, downloaded to a storage device not shown in the drawing from a server or the like which is connected with a network via a network interface. Further, such a processing program may be recorded in a storage medium such as a CD-R and may be led in a storage device via a recording medium drive not shown in the drawing. Further, each peripheral circuit may be constituted of an ASIC or the like.

The information processing unit 880 (including a function of a shift signal transfer unit), even when the information processing unit 880 acquires a shift signal of the pointing device or a button-switch push-down signal via the pointing device interface 852, has a function of transmitting the shift signal of the pointing device and the button-switch push-down signal to the projection device 100 via the command signal transmitting unit such as the wireless transmitting/receiving unit 861 or the wired transmitting/receiving unit 862 without executing processing which directly transfers the acquired shift signal of the pointing device or the acquired button-switch push-down signal.

Further, the information processing unit 880 (including the function of the shift signal transfer unit), even when the information processing unit 880 acquires a button-switch push-down signal of the keyboard via the input interface 871, has a function of transmitting the button-switch push-down signal to the projection device 100 via the command signal transmitting unit such as the wireless transmitting/receiving unit 861 or the wired transmitting/receiving unit 862 without executing processing which directly transfers the acquired button-switch push-down signal to the application program.

Further, the information processing unit 880 (including the function of the shift signal transfer unit) has a function of acquiring a shift signal for shifting the pointer image 16 or a button-switch push-down signal of the keyboard from the projection device 100 via the command signal receiving unit such as the wireless transmitting/receiving unit 861 or the wired transmitting/receiving unit 862 and a function of transferring such shift signal or button-switch push-down signal to an operating system or an application program.

Further, the computer devices 800A, 800B, 800C, 800D preliminarily store a button-switch push-down signal of a predetermined keyboard or a combination of push-down signals in the RAM 881, the ROM 883, the memory unit 884 or the like as mask data. The information processing unit 880 (including a function of a filter unit) may be configured such that the information processing unit 880 compares the button-switch push-down signals of the keyboard or the combination of the push-down signals acquired from the input interface 871 or the like and the mask data, and selects button-switch push-down signals or the combination of the push-down signals which do not correspond to the mask data, and transmits the selected signals to the projection device 100.

Further, the information processing unit 880 (including a function of a filter unit and a function of a shift signal transfer unit) may be configured such that the information processing unit 880 compares the button-switch push-down signals of the keyboard or the combination of the push-down signals acquired from the projection device 100 via the command signal transmitting unit such as the wireless transmitting/receiving unit 861 or the wired transmitting/receiving unit 862 and the mask data, selects button-switch push-down signals or the combination of the push-down signals which do not correspond to the mask data, and transmits the selected signals to the operating system or the application program.

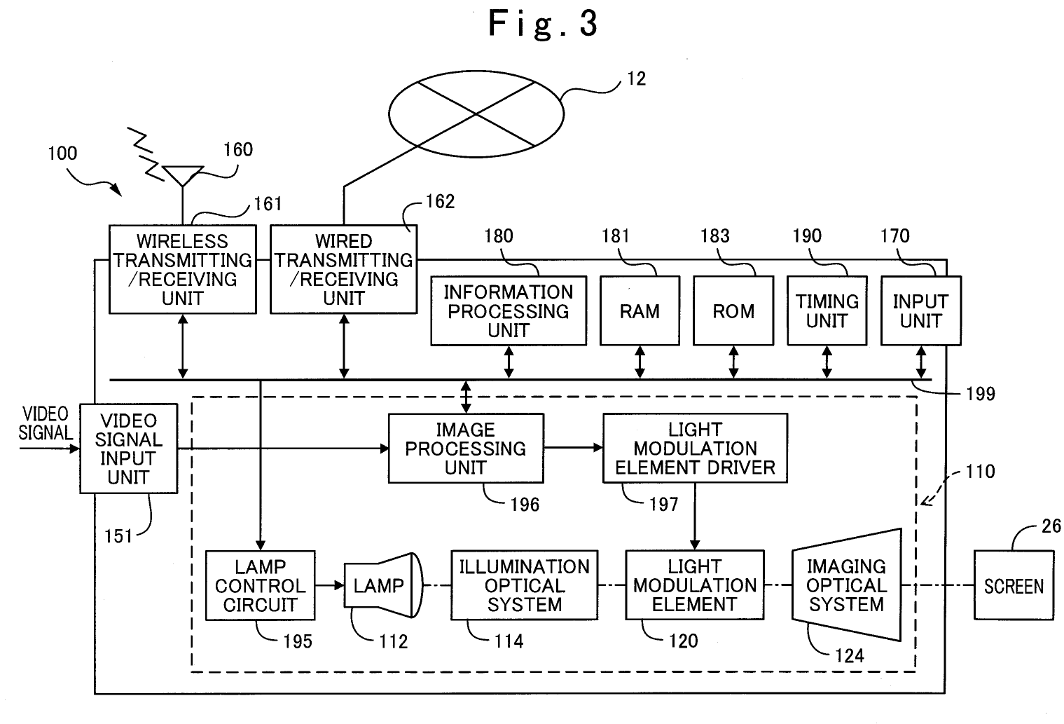

Next, the constitution of the projection device 100 is explained in conjunction with FIG. 3.

FIG. 3 is a block diagram of a signal processing system of the projection device 100.

As shown in FIG. 3, the projection device 100 includes a wireless transmitting/receiving unit 161 (including a function of a receiving unit), a wired transmitting/receiving unit 162 (including a function of a receiving unit), and an input unit 170. Here, the wireless transmitting/receiving unit 161 executes transmitting/receiving processing with other image display devices such as the computer devices 800A, 800B, 800C, 800D by wireless communication by way of an antenna 160 with respect to various information such as a shift signal of the pointing device, a button-switch push-down signal which is generated when the pointing device, the keyboard or the like is operated, computer device identification information, pointer display color information, pointer shape information, information which makes a shift signal for shifting the pointer image 16 and a size of an image associated with each other and a video signal all of which are carried by a carrier wave. The wired transmitting/receiving unit 162 executes transmitting/receiving processing with other image display devices such as the computer devices 800A, 800B, 800C, 800D via the wired communication line 12 with respect to the above-mentioned various information carried on a carrier wave. The input unit 170 is constituted of cursor button switches, switches and the like, and allows a user to input various information therein.

The projection device 100 also includes a lamp 112 which emits an illumination light due to electricity supplied from a lamp control circuit 195, an illumination optical system 114 which collects diffused light emitted from the lamp 112 and radiates more uniform illumination light to an optical modulation element 120, the optical modulation element 120 which receives inputting of the illumination light and generates an image by expressing gradations for respective pixels, and an imaging optical system 124 which projects the image generated by the optical modulation element 120 on a screen 26. As the optical modulation element 120, for example, a DMD (Digital Micromirror Device) or a liquid crystal display element can be used.

The projection device 100 also includes a video signal input unit 151, an image processing unit 196, and an optical modulation element driver 197. Here, the video signal input unit 151 receives inputting of a video signal from other image display device such as the computer devices 800A, 800B, 800C, 800D and converts the video signal into digital image data. The image processing unit 196 acquires the image data via the video signal input unit 151 or a bus 199, applies image processing such as sharpness correction, gamma correction, contrast correction, white balance correction or the like to the image data when necessary, and outputs the image data for display to the optical modulation element driver 197. The optical modulation element driver 197, based on the image data acquired from the image processing unit 196, outputs a signal electrode drive signal which is applied to signal electrodes of the optical modulation element 120 and a scanning electrode drive signal which is applied to scanning electrodes. The optical modulation element 120 forms an image based on the signal electrode drive signal and the scanning electrode drive signal acquired from the optical modulation element driver 197.

The projection unit 110 is constituted of the image processing unit 196, the optical modulation element driver 197, the lamp control circuit 195, the lamp 112, the illumination optical system 114, the optical modulation element 120 and the imaging optical system 124. The projection unit 110 can project the projection image 27 based on the image data acquired via the video signal input unit 151 or the bus 199 and, at the same time, can project the pointer image 16 at a position set by the pointer image position setting unit such as the information processing unit 180.

The projection device 100 includes the information processing unit 180 which executes following processing, that is, formation of the pointer image 16, setting of a display color of the pointer image 16, setting of a shape of the pointer image 16, setting of a position of the pointer image 16, instruction of projection of the pointer image 16, processing of adding shift signals of a plurality of pointing devices to a pointer image position set in the projection device, processing of arranging a plurality of images within one image, processing of adjusting sizes of a plurality of images so as to arrange the images within one image and by acquiring a size of the image after adjustment, processing of associating the shift signal for shifting the pointer image 16 and the size of the image after adjustment, processing of associating regions of a plurality of images, and the computer device which outputs the images, processing of the specification of the computer device which outputs the image indicated by the pointer image 16, processing of comparing the mask data and button-switch push-down signals of the keyboard or the combination of the push-down signals, and processing of controlling the whole projection device 100.

Further, the projection device 100 also includes a RAM 181 which is used as a working region when the information processing unit 180 executes the processing, a ROM 183 which records various information containing the processing program which the information processing unit 180 executes, constants and the like, and a counter unit 190 which counts time. Here, the RAM 181, the ROM 183 or the like can store button-switch push-down signals of a predetermined keyboard or the combination of these push-down signals as mask data.

The respective peripheral circuits within the projection device 100 including the information processing unit 180, the wireless transmitting/receiving unit 161, the wired transmitting/receiving unit 162, the image processing unit 196, the RAM 181, the ROM 183, the counter unit 190, the lamp control circuit 195, the image processing unit 196, the input unit 170 and the like are connected with each other by the bus 199 so as to control the respective peripheral circuits based on the processing program executed by the information processing unit 180. Here, the processing program which is executed by the information processing unit 180 may be, for example, downloaded to a storage device not shown in the drawing from a server or the like which is connected with a network via a network interface. Further, such a processing program may be recorded in a storage medium such as a CD-R and may be read in a storage device via a recording medium drive not shown in the drawing. Further, each peripheral circuit may be constituted of an ASIC or the like.

The wireless transmitting/receiving unit 161 (including a function of a receiving unit) or the wired transmitting/receiving unit 162 (including a function of a receiving unit) can receive, from the plurality of respective computer devices 800A, 800B, 800C, 800D, computer device identification information which identifies the computer device 800A, 800B, 800C, 800D and a shift signal of a pointing device which is connected with the computer device 800A, 800B, 800C, 800D in an associated manner.

Further, the wireless transmitting/receiving unit 161 (including a function of a transmitting unit) or the wired transmitting/receiving unit 162 (including a function of a transmitting unit) includes a function of transmitting a shift signal for shifting the pointer image 16 within the projection image 27, a button-switch push-down signal of the pointing device or a button-switch push-down signal of the keyboard with respect to the specified computer device 800A to 800D. Further, the wireless transmitting/receiving unit 161 (including a function of a transmitting unit) or the wired transmitting/receiving unit 162 (including a function of a transmitting unit) includes a function of transmitting a shift signal for shifting the pointer image 16 within the projection image 27, and a size of the image after adjustment to the specified computer device 800A to 800D in an associated manner.

Further, the wireless transmitting/receiving unit 161 (including a function of a receiving unit) or the wired transmitting/receiving unit 162 (including a function of a receiving unit) can also receive, from the plurality of respective computer devices 800A, 800B, 800C, 800D, display color information of the pointer image 16 and a shift signal of the pointing device which is connected with the computer devices 800A, 800B, 800C, 800D in an associated manner.

Further, the wireless transmitting/receiving unit 161 (including a function of a receiving unit) or the wired transmitting/receiving unit 162 (including a function of a receiving unit) can also receive, from the plurality of respective computer devices 800A, 800B, 800C, 800D, shape information of the pointer image 16 and a shift signal of the pointing device which is connected with the computer device 800A, 800B, 800C, 800D in an associated manner.

The wireless transmitting/receiving unit 161 (including a function of a video signal receiving unit), the wired transmitting/receiving unit 162 (including a function of a video signal receiving unit) or the video signal input unit 151 (including a function of a video signal receiving unit) has a function of receiving a plurality of video signals from the plurality of computer devices 800A, 800B, 800C, 800D.

The wireless transmitting/receiving unit 161 (including a function of a receiving unit) or the wired transmitting/receiving unit 162 (including a function of a receiving unit) also has a function of receiving, from a specified computer device and other computer devices excluding the specified computer device, a shift signal of the pointing device which is connected with these computer devices.

Further, the input unit 170, the wireless transmitting/receiving unit 161, the wired transmitting/receiving unit 162 or the information processing unit 180 has a function of a pointer projection instruction acquisition unit which, using a shift signal of the pointing device which is received from the specified computer device 800A, 800B, 800C, 800D, acquires an instruction whether or not the pointer image 16 for the pointing device is to be projected independently.

Further, the wireless transmitting/receiving unit 161 (including a function of a receiving unit) or the wired transmitting/receiving unit 162 (including a function of a receiving unit) has a function of receiving a button-switch push-down signal or a button-switch push-down releasing signal of the pointing device which is connected with the plurality of computer devices 800A, 800B, 800C, 800D from the plurality of computer devices 800A, 800B, 800C, 800D.

The information processing unit 180 (including a function of an image arranging unit) has a function of arranging a plurality of images formed based on a plurality of video signals received from other image display devices in a state that the plurality of images is synthesized within one image. Further, the information processing unit 180 (including a function of an image arranging unit) has a function of synthesizing and arranging a plurality of images formed based on a plurality of video signals received from the plurality of computer devices 800A, 800B, 800C, 800D within one image and, at the same time, acquiring a size of the image after adjustment for the respective computer devices 800A to 800D.

Further, the information processing unit 180 (including a function of an image region identification information forming unit) has a function of forming image region identification information in which regions of one or a plurality of images which the video arranging unit synthesizes and arranges and the computer device identification information which specify the computer device 800A, 800B, 800C, 800D which output the images are associated with each other.

Further, the information processing unit 180 (including a function of a pointer image forming unit) has a function of forming a pointer image 16 of the pointing device such as a mouse 830. Further, the information processing unit 180 (including a function of a pointer image position setting unit) has a function of setting a position of the pointer image 16 based on shift signals of pointing devices received from other display devices.

Further, the information processing unit 180 (including a function of a computer device specifying unit) has a function of specifying the computer device 800A which outputs an image of a projection image 27A pointed out by a pointer image 16 from a projection position of the pointer image 16 which is set by the pointer image position setting unit and image region identification information.

Further, the projection device 100 preliminarily stores predetermined button-switch push-down signals of the keyboard or the combination of the button-switch push-down signals in a mouse data memory unit such as the RAM 181 or the ROM 183 as mask data while the information processing unit 180 (including a function of a filter unit) has a function of comparing the button-switch push-down signals of the keyboard received from the computer devices 800A, 800B, 800C, 800D or the combination of these push-down signals and the mask data, selecting the button-switch push-down signals or the combination of the button-switch push-down signals which do not correspond to the mask data, and transmitting the selected button-switch push-down signal or the combination of the button-switch push-down signals to the specified computer device 800A which outputs an image of a projection image 27A pointed out by a pointer image 16.

Further, the information processing unit 180 (including a function of a pointer image forming unit) has a function of specifying display color of a pointer image 16 corresponding to the computer device identification information received from other image display devices, and associating the display color of the pointer image 16 with a shift signal of the pointing device. Further, the information processing unit 180 (including a function of a pointer image position setting unit) has a function of setting a position of the pointer image 16 of display color associated with a received shift signal of the pointing device based on such a shift signal.

Further, the information processing unit 180 (including a function of the pointer image forming unit) has a function of specifying display color of the pointer image 16 in accordance with display color information of the pointer image 16 received from other image display devices, and associating the display color of the pointer image 16 with a shift signal of the pointing device. Further, the information processing unit 180 (including the function of the pointer image position setting unit) has a function of setting a position of the pointer image 16 of display color associated with a received shift signal of the pointing device based on such a shift signal.

Further, the information processing unit 180 (including a function of the pointer image forming unit) has a function of specifying a pointer shape corresponding to computer device identification information received from other image display devices, and associating the pointer shape with the shift signal of the pointing device. Further, the information processing unit 180 (including the function of the pointer image position setting unit) has a function of setting a position of the pointer image 16 having the shape associated with a received shift signal of the pointing device based on such a shift signal.

Further, the information processing unit 180 (including a function of the pointer image forming unit) has a function of specifying a pointer shape in accordance with pointer shape information received from other image display devices, and associating the pointer shape with the shift signal of the pointing device. Further, the information processing unit 180 (including the function of the pointer image position setting unit) has a function of setting a position of the pointer image 16 having the shape associated with a received shift signal of the pointing device based on such a shift signal.

Further, the information processing unit 180 (including a function of a shift signal adding unit) has a function of forming a shift signal by adding shift signals of a plurality of pointing devices received from other image display devices to a position of a pointer image set by the projection device.

Further, the information processing unit 180 (including a function of a shift signal adding unit) has a function of forming a shift signal by adding shift signals of pointing devices received from a plurality of computer devices excluding a specified computer device to a position of a pointer image set by the projection device. Further, the information processing unit 180 (including the function of the pointer image forming unit) has a function of forming a plurality of pointer images 16 of the pointing devices. Still further, the information processing unit 180 (including the function of the pointer image position setting unit) has a function of setting a position of a first pointer image based on the added shift signal and, at the same time, a function of setting a position of a second pointer image based on a shift signal of the pointing device of the specified computer device.

The information processing unit 180 (including a function of a pointer image forming unit) has a function of forming one or a plurality of pointer images of pointing devices. When a pointer projection instruction acquiring unit such as the information processing unit 180 receives an instruction that the pointer image 16 for the pointing device is not independently projected using a shift signal of the pointing device received from the specified computer device, the information processing unit 180 (including a function of a shift signal adding unit) has a function of forming a shift signal by adding the shift signals received from the specified computer device and other computer devices to a position of the pointer image set by the projection image. In this case, the information processing unit 180 (including a function of the pointer image position setting unit) executes processing of setting a pointer image position based on the formed shift signal, and projects at least the pointer image 16 at the set position.

Further, the information processing unit 180 (including the function of the shift signal adding unit) has a function of, when the pointer projection instruction acquiring unit such as the information processing unit 180 receives an instruction that the pointer image for the pointing device is independently projected and shifted using the shift signal of the pointing device received from the specified computer device, forming a shift signal by adding the shift signals received from the above-mentioned other computer devices to the pointer image position set by the projection device. In this case, the information processing unit 180 (including the function of the pointer image position setting unit) sets a position of a first pointer image based on the added shift signal, executes processing of setting a position of a second pointer image based on the above-mentioned shift signal of the pointing device of the specified computer device, and project a plurality of pointer images at least at the set position.

Further, the pointer projection instruction acquiring unit such as the information processing unit 180 has a function of acquiring a predetermined quantity of shift signal in a state that a button-switch push-down signal of the pointing device is acquired from a specified computer device, and a function of changing over a state of the pointer image 16 between a state in which the pointer image 16 for the pointing device is independently projected and shifted using the shift signal of the pointing device received from the specified computer device and a state in which the pointer image 16 is not independently projected when a button-switch push-down release signal of the pointing device is acquired after the acquisition of the shift signal of a predetermined quantity.

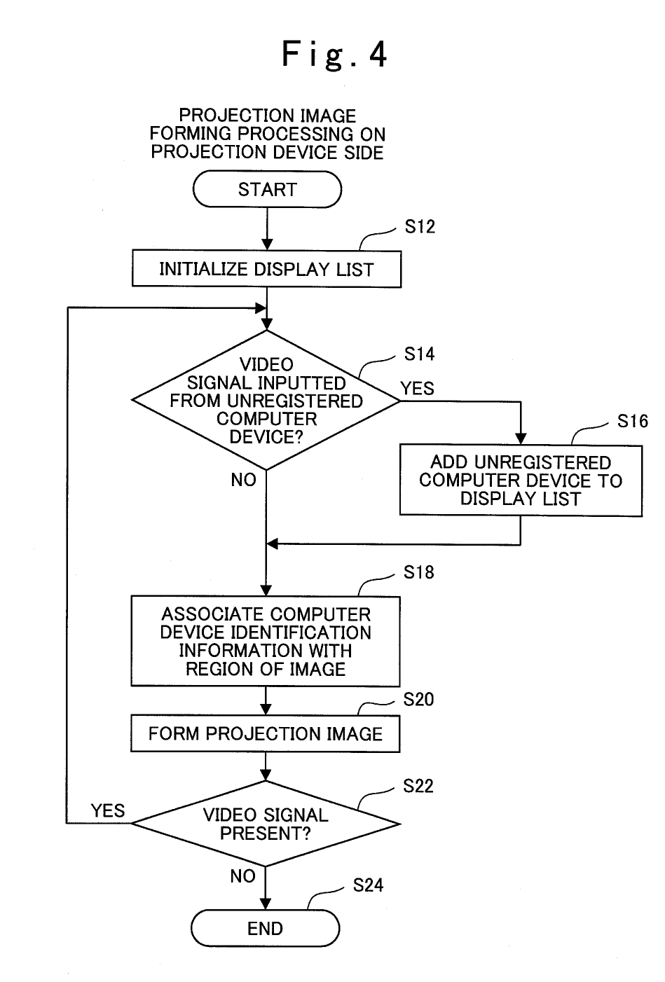

Next, the projection image forming processing which the projection device 100 executes is explained in conjunction with FIG. 4.

FIG. 4 is a flowchart of projection image forming processing which the information processing unit 180 of the projection device 100 executes.

When the processing of the projection device 100 is initialized immediately after a power source of the projection device 100 is inputted, the image forming processing which the information processing unit 180 of the projection device 100 executes advances to step S12 “initialize display list” (hereinafter described as “S12” in an abbreviated manner) so that the display list is initialized. A content of the display list is explained in detail later in conjunction with step S16.

With respect to the determination in next step S14 “video signal inputted from unregistered computer device?”, the information processing unit 180 makes an inquiry to the image processing unit 196 on whether or not the video signal input unit 151 receives a video signal from the unregistered computer device 800A, 800B, 800C, 800D. When the video signal input unit 151 does not receive the video signal from the unregistered computer device 800A, 800B, 800C, 800D, the processing which the information processing unit 180 executes advances to step S18 “associate computer device identification information with region of image”. On the other hand, when video signal input unit 151 receives the video signal from the unregistered computer device 800A, 800B, 800C, 800D, the processing which the information processing unit 180 executes advances to processing in step S16 “add unregistered computer device to display list”.

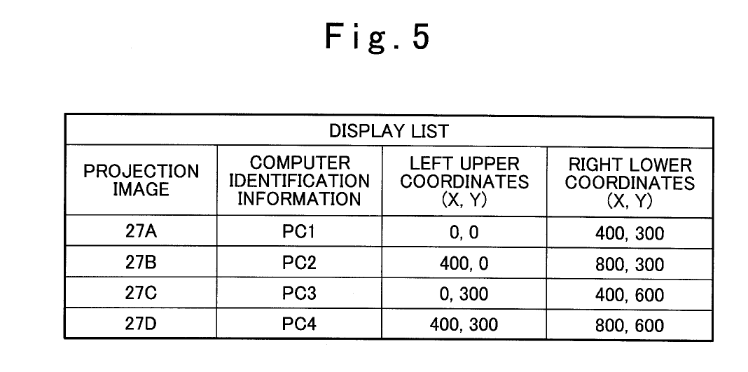

In step S16, the information processing unit 180 executes processing of the registration of unregistered computer device 800A, 800B, 800C, 800D in the display list. A constitutional example of the display list is shown in FIG. 5.

FIG. 5 shows a mode of image region identification information in which a region of an image and computer device identification information which specifies the computer device which outputs the image are associated with each other.

In the mode shown in FIG. 5, four sets of terminal devices having computer device identification information PC1 to PC4 are registered in a display list. As can be understood from FIG. 5, when four sets of terminal devices are registered in the display list, the projection image 27 is split in four as shown in FIG. 1 thus arranging and displaying a projection image 27A which the computer device 800A (PC1) outputs, a projection image 27B which the computer device 800B (PC2) outputs, a projection image 27C which the computer device 800C (PC3) outputs, and a projection image 27D which the computer device 800D (PC4) outputs within one image.

Here, when only the terminal device having the computer device identification information designated by PC1, for example, is registered in the display list, one projection image 27A which the computer device 800A (PC1) outputs is displayed on the whole surface of the projection image 27 shown in FIG. 1.

Next, the processing in step S18 and the processing in steps which follow the processing in step S18 shown in FIG. 4 are explained. In step S18, the information processing unit 180 executes processing of the generation of image region identification information in which regions of one or a plurality of images and the computer device identification information which specifies the computer devices which output the images are associated with each other.

In next step S20 “form projection image”, the information processing unit 180 executes processing of forming the projection image 27 which arranges one or a plurality of images generated from one or a plurality of video signals, and advances to the determination in next step S22 “video signal present?”.

In step S22, the information processing unit 180 makes an inquiry to the image processing unit 196 on whether or not the video signal input unit 151 acquires a video signal. When the information processing unit 180 acquires the information that the video signal input unit 151 receives a video signal from the image processing unit 196, the processing which the information processing unit 180 executes returns to step S14, and the information processing unit 180 determines whether or not the video signal is inputted from the unregistered computer devices 800A, 800B, 800C, 800D again.

Further, when the information processing unit 180 does not acquire the information that the video signal input unit 151 receives the video signal from the image processing unit 196, the processing which the information processing unit 180 executes advances to “END” in step S24 and projection image forming processing is finished.

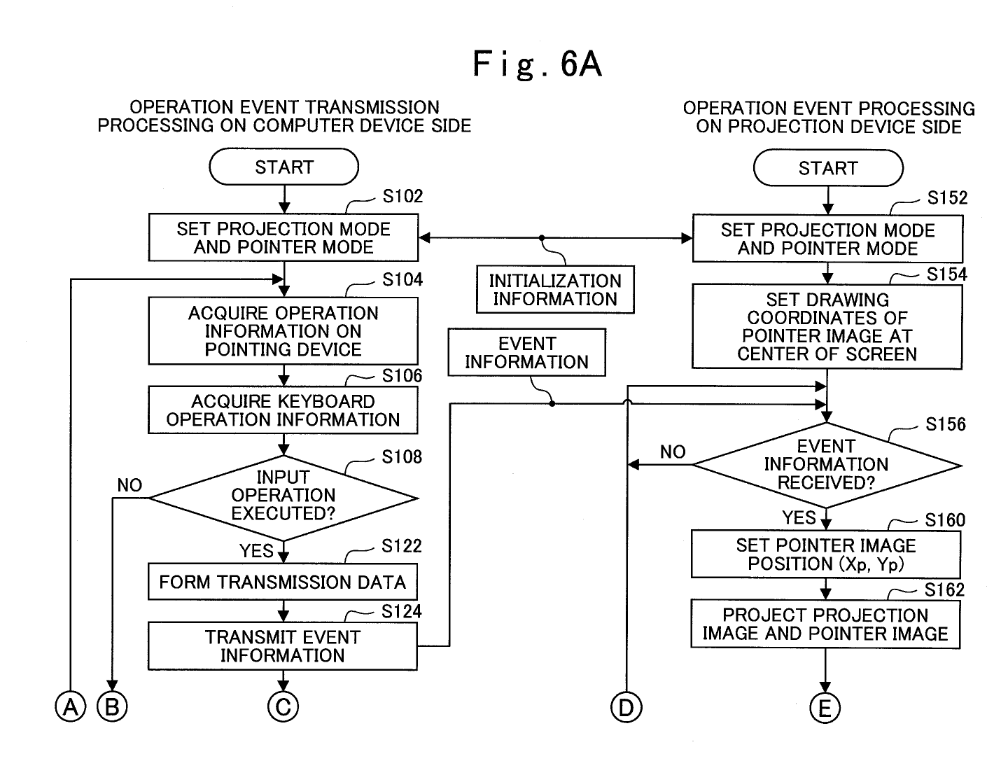

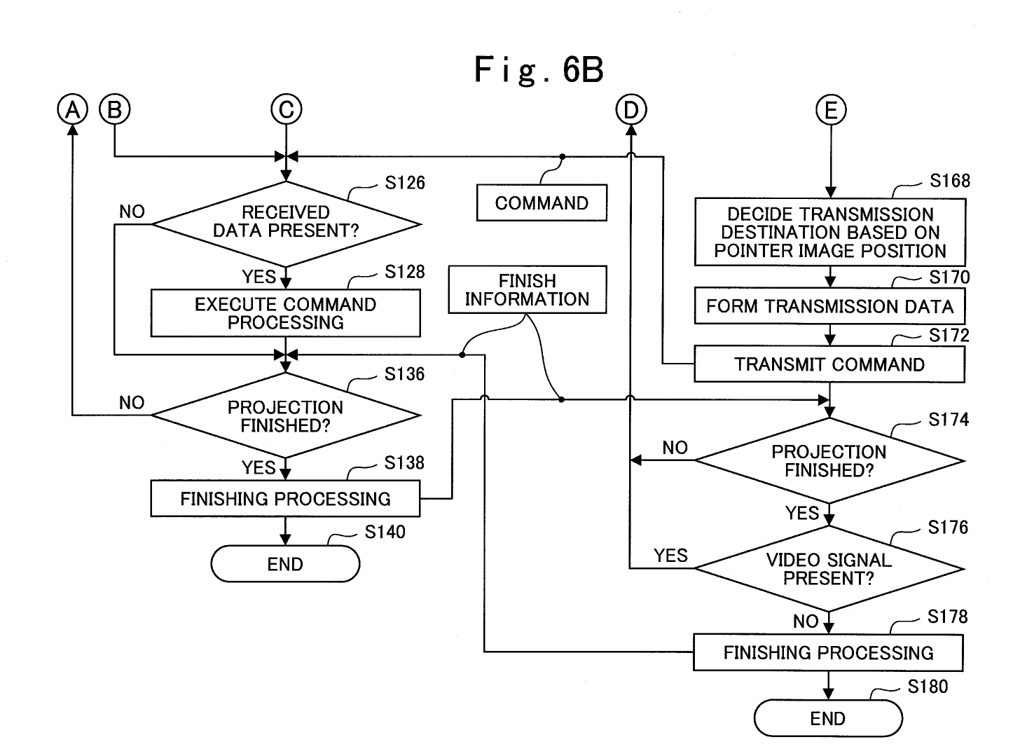

Next, the operation event processing which the computer devices 800 and the projection device 100 execute is explained in conjunction with FIG. 6A and FIG. 6B.

FIG. 6A and FIG. 6B are flowcharts of operation event transmission processing which the information processing unit 880 of the computer device 800 executes and the operation event processing which the information processing unit 180 of the projection device 100 executes.

When a user instructs the projection of an image by operating the input unit 170 mounted on the projection device 100 or the like, the processing which the information processing unit 180 of the projection device 100 executes advances to the processing in step S152 “set projection mode and pointer mode” and sets a projection mode and a pointer mode.

Here, setting of the projection mode includes setting of a plural-image display mode in which a plurality of images acquired from a plurality of computer devices is arranged in the projection image 27 which the projection device 100 projects. Once the projection mode is decided, the processing of storing various setting information such as resolution of the image received from the computer device 800, resolution of the projection image 27, the number or a quantity of images arranged in the projection image 27 in the RAM 181 is executed. Further, setting of the pointer mode performed in this step includes setting of pointer attributes such as a display color, a shape, a trajectory and an operation of the pointer image to be projected.

When the setting of the projection mode and the pointer mode is executed in step S152, the initialization information which includes the mode setting information is stored in a memory unit such as the RAM 181 and, at the same time, the initialization information is transmitted to one or a plurality of computer devices 800 which is communicably connected with the projection device 100 via a communication unit such as the wireless transmitting/receiving unit 161 or the wired transmitting/receiving unit 162 of the projection device 100.

Then, the processing which the information processing unit 180 of the projection device 100 executes advances to step S154 “set drawing coordinates of pointer image at center of screen”, and the information processing unit 180 sets a numerical value half of resolution of the projection image 27 as an initial value of the projection position of the pointer image 16. For example, when the resolution of the projection image 27 is 800 dots×600 dots, Xp=400, Yp=300 are put in the display list as the initial value of the projection position (Xp, Yp) of the pointer image 16 and are stored in the RAM 181.

On the other hand, in step S102 “set projection mode and pointer mode”, the computer device 800 receives initialization information which includes mode setting information via a communication unit such as the wireless transmitting/receiving unit 861 or the wired transmitting/receiving unit 862, stores the initialization information in the memory unit such as the RAM 881, and executes processing of setting a projection mode and a pointer mode.

Then, the information processing unit 880 executes processing of setting a mode in which the event information such as the shift signal (ΔX, ΔY) of the pointing device acquired from the mouse 830 or the like, the button-switch push-down signal and the button-switch push-down release signal are transmitted to the projection device 100 via a communication unit such as the wireless transmitting/receiving unit 861 or the wired transmitting/receiving unit 862 without transferring the event information to the application program.

Further, the information processing unit 880 executes processing of the acquisition of the shift signal for shifting the pointer image 16 or the button-switch push-down signal of the keyboard from the projection device 100 via the command signal receiving unit such as the wireless transmitting/receiving unit 861 or the wired transmitting/receiving unit 862 and processing of the transfer of the acquired shift signal or the button-switch push-down signal to the operating system or the application program. Here, scroll information of a wheel or the like acquired from the mouse 830 may be transferred to the application program of the computer device 800 without being transmitted to the projection device 100.

In the above-mentioned explanation, the embodiment in which setting of the projection mode and setting of the pointer mode are performed on a projection device 100 side is explained. However, the embodiment may be configured such that the setting of the projection mode and setting of the pointer mode are performed on a computer device 800 side. In this case, initialization information containing mode setting information may be transmitted to the projection device 100 from the computer device 800, and setting processing of the projection mode and the pointer mode is performed on respective devices.

When setting processing of the projection mode and the pointer mode is finished in step S102, the processing which the information processing unit 880 executes advances to processing in next step S104 “acquire operation information on pointing device” in which the processing of checking a buffer of the pointing device interface 852 by interruption or polling and processing of the acquisition of the shift signal of the pointing device, the button-switch push-down signal or the button-switch push-down release signal via the bus 899 are executed. Then, the processing advances to next step S106 “acquire keyboard operation information” in which the processing of checking a buffer of the input interface 871 by interruption or polling and processing of the acquisition of the button-switch push-down signal or the button-switch push-down release signal of the keyboard or the like are executed.

In the determination in next step S108 “input operation executed?”, it is determined whether or not the input operation is executed by the user by determining whether or not the operation information of the pointing device or the key board operation information is acquired in step S104 or in step S106.

When the information processing unit 880 determines that the input operation is executed by the user, processing of reading pointer attributes such as a display color, a shape, a trajectory, an operation and the like of the pointer image 16 stored in the RAM 881 is executed, and the processing advances to processing in next step S122 “form transmission data”. On the other hand, when the information processing unit 880 determines the input operation is not executed by the user, the processing is branched and advances to the determination in step S126 “received data present?”.

In step S122, the information processing unit 880 executes processing of forming transmission data of event information containing the operation information of the pointing device acquired in step S104 and the keyboard operation information acquired in step S106.

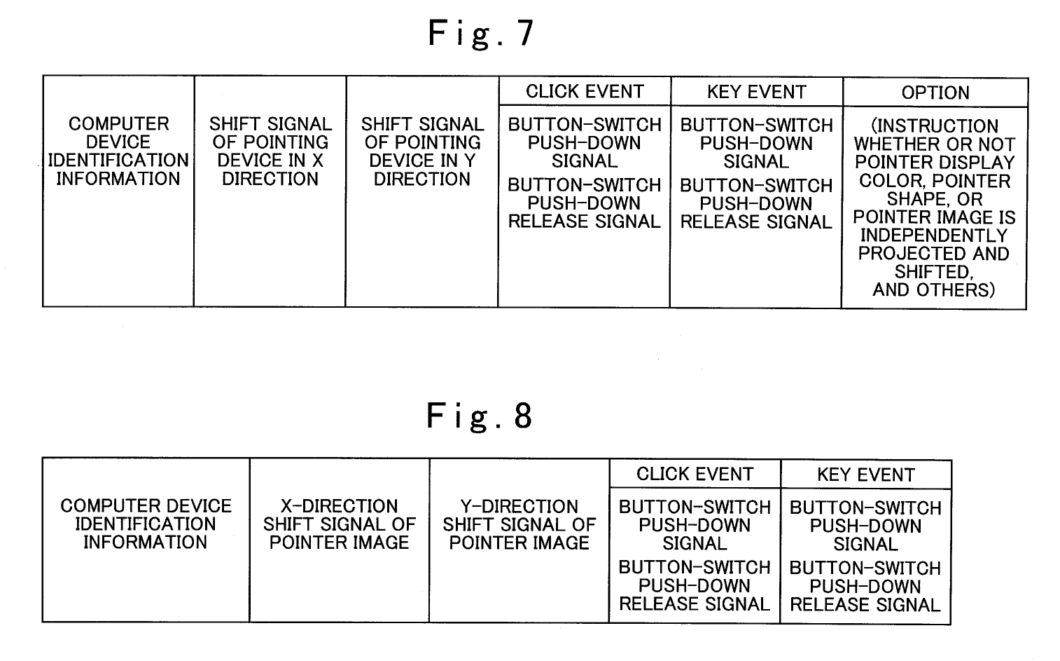

FIG. 7 shows a structural example of event information contained in a command signal formed in step S122.

As shown in FIG. 7, the event information contains an X-direction shift signal and a Y-direction shift signal indicative of shifting quantities of the pointing device in the X direction and in the Y direction, the button-switch push-down signal of the pointing device and the button-switch push-down signal of the key board. Further, in the processing which the projection device 100 executes, when needed, the computer device identification information of a transmitter which transmits the event information and the shift signal of the pointing device may be associated with each other. Further, other information and other signals may be associated with each other as follows. That is, the display color information of the pointer image 16 and the shift signal of the pointing device may be associated with each other, the pointer shape information of the pointer image 16 and the shift signal of the pointing device may be associated with each other, the computer device identification information and the button-switch push-down signal and the button-switch push-down release signal of the pointing device or the keyboard may be associated with each other, and the computer device identification information and information on the instruction whether or not the pointer image 16 is to be projected may be associated with each other.

When the formation of the transmission data of event information is finished in step S122, the processing advances to next step S124 “transmit event information”. In this step S124, the information processing unit 880 outputs an address and a transmission command to the wireless transmitting/receiving unit 861 or the wired transmitting/receiving unit 862 and, at the same time, outputs event information via the bus 899. In response to such an outputting of the event information, the computer device 800 executes processing of the transmission of the event information to the projection device 100 via the wireless transmitting/receiving unit 861 or the wired transmitting/receiving unit 862. When the transmission of the event information is finished, the processing which the information processing unit 880 executes advances to the determination in step S126 “received data present?”.

In step S126, the information processing unit 880 checks a buffer of a command signal receiving unit such as the wireless transmitting/receiving unit 861 or the wired transmitting/receiving unit 862, and determines whether or not the command signal receiving unit acquires the receiving data such as a shift signal for shifting the pointer image 16 or the button-switch push-down signal of the keyboard from the projection device 100. When the receiving data is not present, the processing advances to the determination in step S136 “projection finished?”, while when the receiving data is present, the processing advances to processing in step S128 “execute command processing”.

In step S128, the information processing unit 880 executes processing of the transfer of a shift signal for shifting the pointer image 16 or a button-switch push-down signal of the keyboard acquired from the projection device 100 to the operating system or the application program. Then, in the application program which the information processing unit 880 executes, processing of the specification of a position of the pointer image 16 based on the acquired shift signal, processing of emphasizing a button-switch on the projection image 27A and processing of flickering a cursor of the dialog box are executed.

FIG. 8 shows a structural example of a command contained in a specified command signal transmitted from the projection device 100.

As shown in FIG. 8, a command transmitted from the projection device 100 contains an X-direction shift signal and a Y-direction shift signal indicative of shifting quantities of the pointer image 16 in the X direction and in the Y direction, a button-switch push-down signal (click event) of the pointing device for shifting the pointer image 16, and a button-switch push-down signal of the keyboard (key event) which transfers the shift signal to an application program of the computer device 800A which displays a projection image 27 which the pointer image 16 points out. Further, when needed, the computer device identification information may be associated with the shift signal of the pointing device, the click event or the key event. The key event contains text information inputted to a dialog box or the like, a shortcut key and the like.

In next step S136“projection finished?”, the information processing unit 880 investigates a buffer of the wireless transmitting/receiving unit 861 or the wired transmitting/receiving unit 862, and executes the determination whether or not a command of projection finishing is transmitted from the projection device 100. Alternatively, the information processing unit 880 investigates a buffer of the input interface 871, and executes the determination whether or not a command of projection finishing is acquired from a user.

When the information processing unit 880 determines that the command of projection finishing is acquired in step S136, the processing which the information processing unit 880 executes advances to next step S138 “finishing processing”, while when the information processing unit 880 determines that the command of projection finishing is not acquired in step S136, the processing returns to the processing in step S104.

In step S138, upon acquisition of the command of projection finishing, the information processing unit 880 executes processing of the release of the setting of the projection mode and a pointer mode. Then, the information processing unit 880 sets a usual-use mode in which the information processing unit 880 transfers the event information such as the shift signal (ΔX, ΔY) of the pointing device acquired from the mouse 830 or the like, the button-switch push-down signal and the button-switch push-down release signal to the application program. Then, the processing advances to next step S140 “END” thus finishing a routine of the operation event transmission processing.

On the other hand, the information processing unit 180 of the projection device 100, in step S156 “event information received?”, executes processing of waiting for the reception of the event information of the pointing device from one or a plurality of computer devices 800 via the wireless transmitting/receiving unit 161 or the wired transmitting/receiving unit 162.

When the event information received from the computer device 800 is not stored in a buffer of the wireless transmitting/receiving unit 161 or the wired transmitting/receiving unit 162, the information processing unit 180 executes the processing in step S156 again.

On the other hand, when the information processing unit 180 further determines that the event information transmitted from the computer device 800 is stored in a buffer of the wireless transmitting/receiving unit 161 or the wired transmitting/receiving unit 162, the information processing unit 180 acquires a display color of a pointer image, a shape of the pointer image, a trajectory of the pointer image, an operation of a pointer and the like which are preliminary set from a memory unit such as the RAM 181 or the ROM 183, and the processing advances to next step S160 “set pointer image position (Xp, Yp)”.

In step S160, the information processing unit 180 acquires a position (Xp, Yp) of the pointer image 16 which is currently set from the RAM 181, and executes processing of setting a position (Xp+ΔX→Xp, Yp+ΔY→Yp) of the pointer image 16 using the shift signal (ΔX, ΔY) of the pointing device acquired in step S156.

Then, in next step S162 “project projection image and pointer image”, the information processing unit 180 outputs an instruction of projecting one or a plurality of pointer images 16 specified in step S160 at the above-mentioned set position together with the image to the image processing unit 196.

Then, as shown in FIG. 1, for example, the pointer image 16 is displayed on the projection image 27. Here, the pointer image 16 may be a pointer image intrinsic to the computer device 800A, for example, or may be a commonly-shared pointer image in which one pointer image 16 is shifted based on shift signals received from a plurality of computer devices 800A, 800B, 800C, 800D.

In shifting the commonly-shared pointer image 16, a shift signal (ΔX, ΔY) is formed by adding the shift signals of the plurality of pointing devices acquired from the plurality of computer devices 800A, 800B, 800C, 800D to the position of the pointer image set by the projection device, and the commonly-shared pointer image 16 is shifted.

In next step S168 “decide transmission destination based on pointer image position”, the information processing unit 180 executes processing of the specification of the computer device 800A which outputs an image pointed out by the pointer image 16 based on the projection position of the pointer image 16 set in step S160 and the image region identification information formed in step S18 shown in FIG. 4. Then, the processing advances to processing in step S170 “form transmission data”.

In step S170, the information processing unit 180 executes processing of forming a command shown in FIG. 8. The computer device identification information shown in FIG. 8 is the identification information which specifies the computer devices 800A, 800B, 800C, 800D which constitute the transmission destinations. The shift signals in the X direction and in the Y direction of the pointer image may be transmitted after calculating a shifting quantity which conforms to display resolutions of the computer devices 800A, 800B, 800C, 800D which constitutes transmission destinations.

Further, in arranging the images received from the plurality of computer devices 800A, 800B, 800C, 800D within one image by adjusting sizes (for example, resolutions) of these images, the sizes of images after adjustment are calculated for the respective computer devices 800A, 800B, 800C, 800D and, at the same time, the sizes of the image on the projection image 27A after adjustment is transmitted to the computer device 800A. Then, when the pointer image 16 is shifted, the size of the image in the projection image 27A may be transmitted to the specified computer device 800A in a state that a shift signal for shifting the pointer image 16 in the projection image 27A, and the size of the image after adjustment are associated with each other. Further, the shift signals of the pointer image in the X direction and in the Y direction may be transmitted after calculating a shifting quantity which is in conformity with the display resolutions of the computer devices 800A, 800B, 800C, 800D which constitute the transmission destinations before the adjustment.

When the transmission data forming processing is finished in step S170, the processing advances to processing in next step S172 “transmit command”, and a command formed in step S170 is transmitted to the computer device 800A specified in S168.

Here, when an absolute position (Xp, Yp) in the projection image 27A is transmitted as a shift signal for shifting the pointer image 16, as shown in FIG. 1, even when the pointer image 16 is shifted from the projection image 27A to the projection image 27D, the computer device 800A and the computer device 800D can specify the position of the pointer image 16.

Further, when a relative shifting quantity (ΔX, ΔY) is transmitted as a shift signal for shifting the pointer image 16, in shifting the pointer image 16 to the projection image 27D from the projection image 27A, an initial value of the position of the pointer image 16 may be transmitted to the computer device 800D. Due to such transmission of the initial value, the respective computer devices 800A, 800B, 800C, 800D can specify the position of the pointer image 16.

In next step S174 “projection finished?”, the information processing unit 180 investigates a buffer of the wireless transmitting/receiving unit 161 or the wired transmitting/receiving unit 162, and executes the determination whether or not a command of projection finishing is transmitted from the computer device 800. Alternatively, the information processing unit 180 investigates an interface buffer of the input unit 170, and executes the determination whether or not a command of projection finishing is acquired from a user.

When the information processing unit 180 determines that the command of projection finishing is acquired in step S174, a projection finishing flag of the computer device 800 which acquires the projection finishing is set, and the processing advances to determination in next step S176 “video signal present?”. On the other hand, when the information processing unit 180 determines that the command of projection finishing is not acquired, the processing returns to the processing in step S156.

In next step S176, the information processing unit 180 makes an inquiry to the image processing unit 196 on whether or not the video signal input unit 151 acquires the video signal. When the information processing unit 180 acquires the information that the video signal input unit 151 receives video signal from the image processing unit 196, the processing which the information processing unit 180 executes returns to step S156, and the projection is continued. On the other hand, when the information processing unit 180 does not acquire the information that the video signal input unit 151 receives video signal from the image processing unit 196 or the projection finishing flag of all computer devices 800A, 800B, 800C, 800D which are communicably connected with each other is set, the processing which the information processing unit 180 executes advances to processing in step S178 “finishing processing”.

In step S178, the information processing unit 180 executes processing of the output of information for finishing the projection of the projection image 27 to the lamp control circuit 195, the image processing unit 196 and the like, and finishes the projection. Then, the processing advances to next step S180 “END”, and finishes a routine of operation event processing.

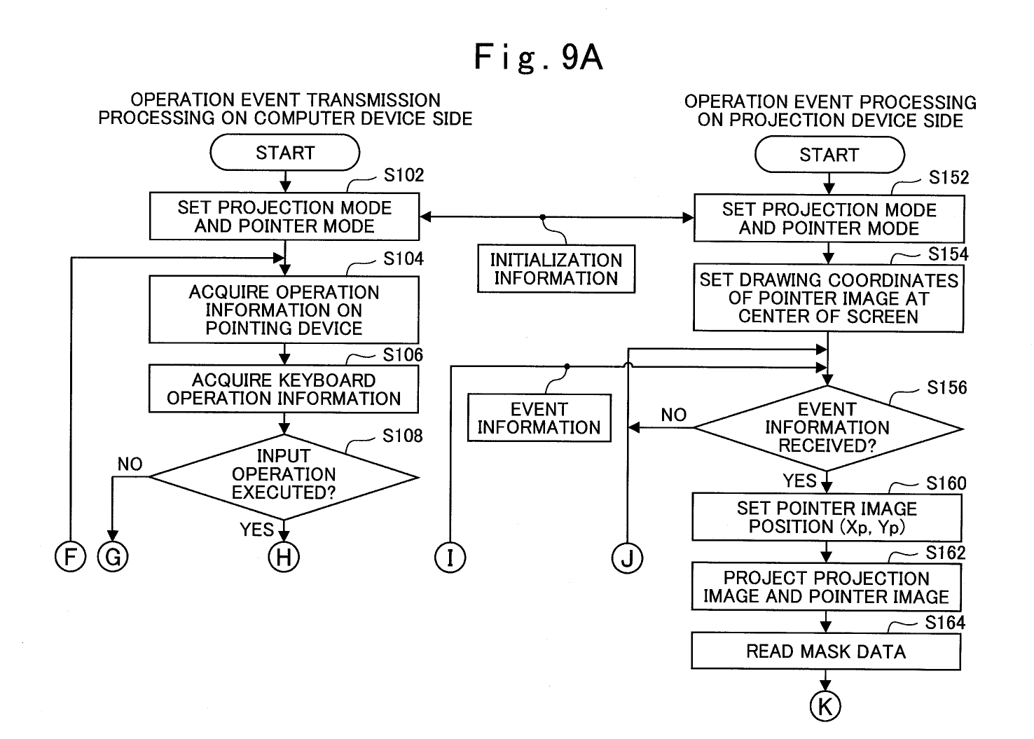

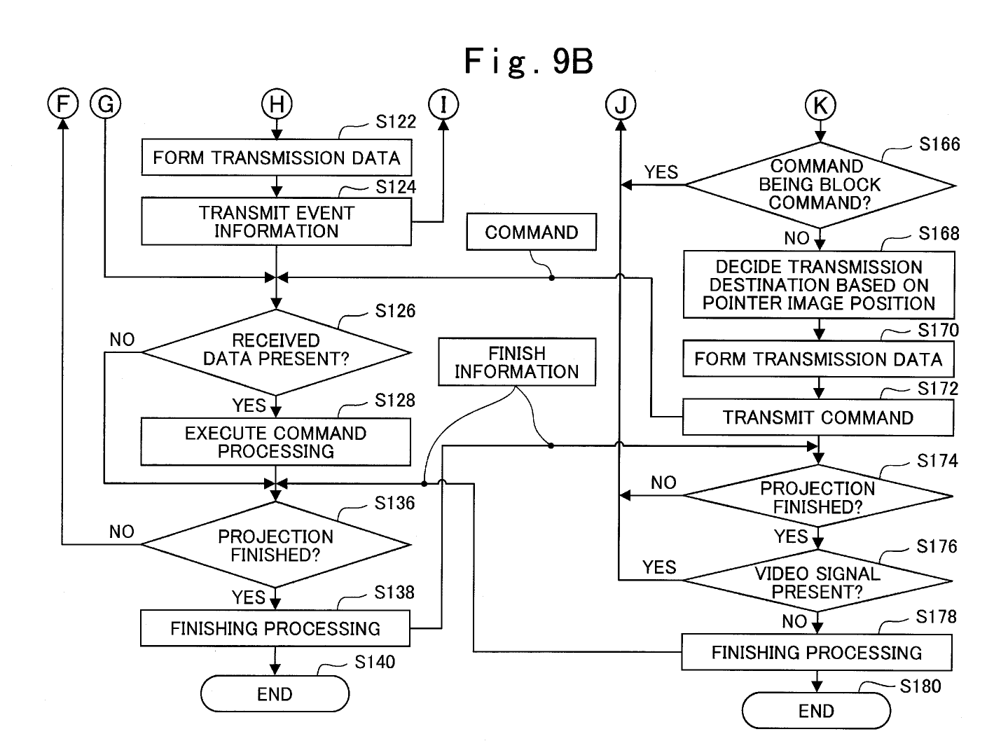

Next, another mode of operation event processing which the computer devices 800A, 800B, 800C, 800D and the projection device 100 execute is explained in conjunction with FIG. 9A and FIG. 9B.

For example, when all button-switch push-down signals of keyboards received from other computer devices 800B to 800D are transmitted to the computer device 800A which outputs an image pointed out by the pointer image 16, a command for operating an operating system irrelevant to the application program instructing the display of the projection image 27A is also transmitted thus giving rise to a possibility that the presentation is obstructed.

Accordingly, in the mode of the operation event processing of this embodiment, the computer devices 800A, 800B, 800C, 800D and the projection device 100 execute the processing of the restriction of the transmission of commands such as a command “logo key (displaying start menu)”, a command “logo key+Break (displaying property of system)”, a command “logo key+D (displaying desktop)”, a command “logo key+M (minimizing all windows)”, a command “logo key+Shift+M (restoring minimized windows)”, a command “logo key+E (opening my computer)”, a command “logo key+F (retrieving file or folder)”, a command “logo key+Ctrl+F (retrieving computer)”, a command “logo key+F1 (displaying help)”, a command “logo key+T (locking computer when computer is connected with network domain)”, a command “logo key+R (executing program by designating file name)”, a command “logo key+U (opening utility manager)”, and a shutdown. A flowchart of processing of blocking these commands which require restriction is shown in FIG. 9A and FIG. 9B.

FIG. 9A and FIG. 9B are the flowcharts of operation event processing in which filter processing is executed to the command transmitted to the specific computer device 800A, 800B, 800C, 800D. Here, the operation event processing shown in FIG. 9A and FIG. 9B is processing which is formed by adding step S164 and S166 to the operation event processing shown in FIG. 6A and FIG. 6B. Accordingly, the explanation of the processing identical to the processing shown in FIG. 6A and FIG. 6B is omitted while giving the same symbols to the processing.

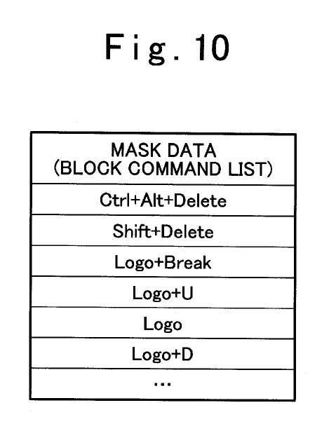

In step S164 “read mask data”, the information processing unit 180 executes processing of reading a list of block commands preliminarily stored in a memory unit such as the ROM 183. An example of the block command list is shown in FIG. 10.

As shown in FIG. 10, mask data is data for masking predetermined signals for the button-switch push-down signals of the keyboards received from the computer devices 800A, 800B, 800C, 800D or the combination of these button-switch push-down signals.

When reading of the mask data is finished in step S164, the processing which the information processing unit 180 executes advances to determination in next step S166 “command being block command?”.

In step S166, the information processing unit 180 executes determination on whether or not the button-switch push-down signals of the keyboards or the combination of the button-switch push-down signals contained in the event information received in step S156 contain mask data.

When the mask data is contained in the button-switch push-down signals of the keyboards or the combination of the button-switch push-down signals, the processing returns to step S156 in which the processing of the acquisition of next event information is executed.

On the other hand, when the mask data is not contained in the button-switch push-down signals of the keyboards or the combination of the button-switch push-down signals, the processing advances to processing in step S168 in which the processing of deciding the computer devices 800A, 800B, 800C, 800D which constitute the transmission destination based on the projection position of the pointer image 16 is executed.

By providing the processing in step S164 and the processing in step S166, it is possible to eliminate the transmission such as a shortcut which is not used in the application program of the computer devices 800A, 800B, 800C, 800D. Further, it is possible to prevent an inappropriate or illegal operation of the computer devices 800A, 800B, 800C, 800D by other users.

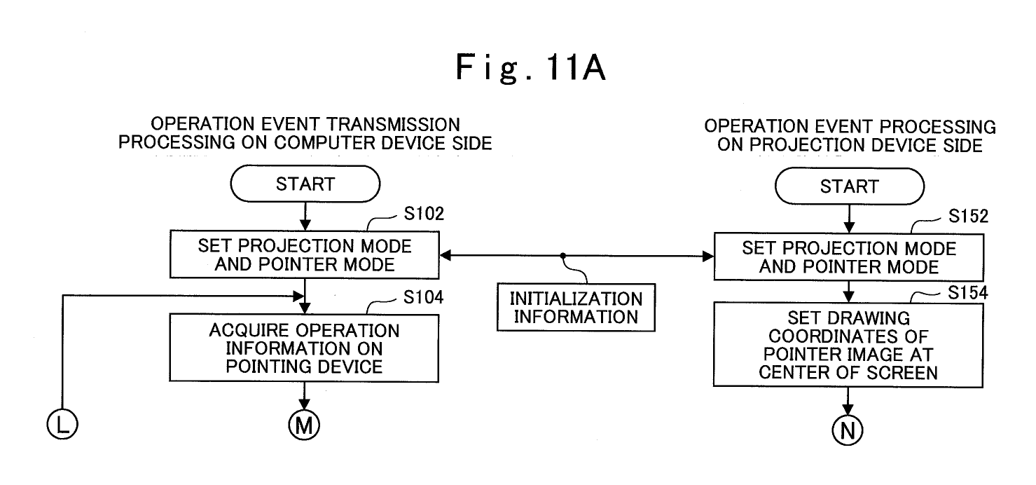

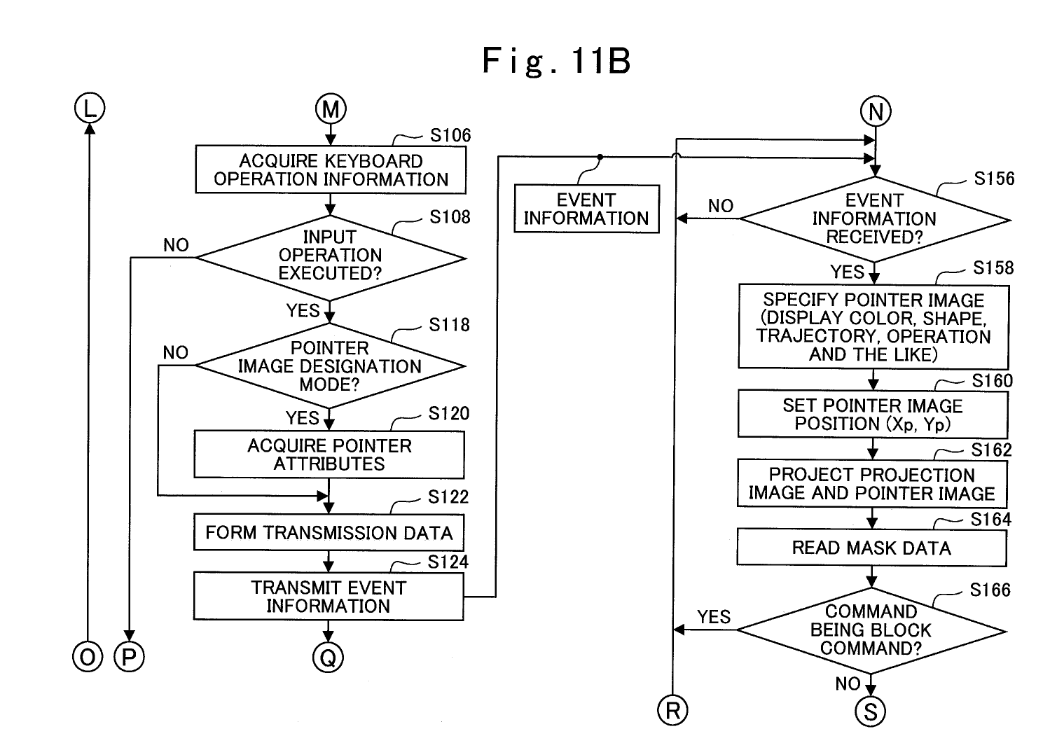

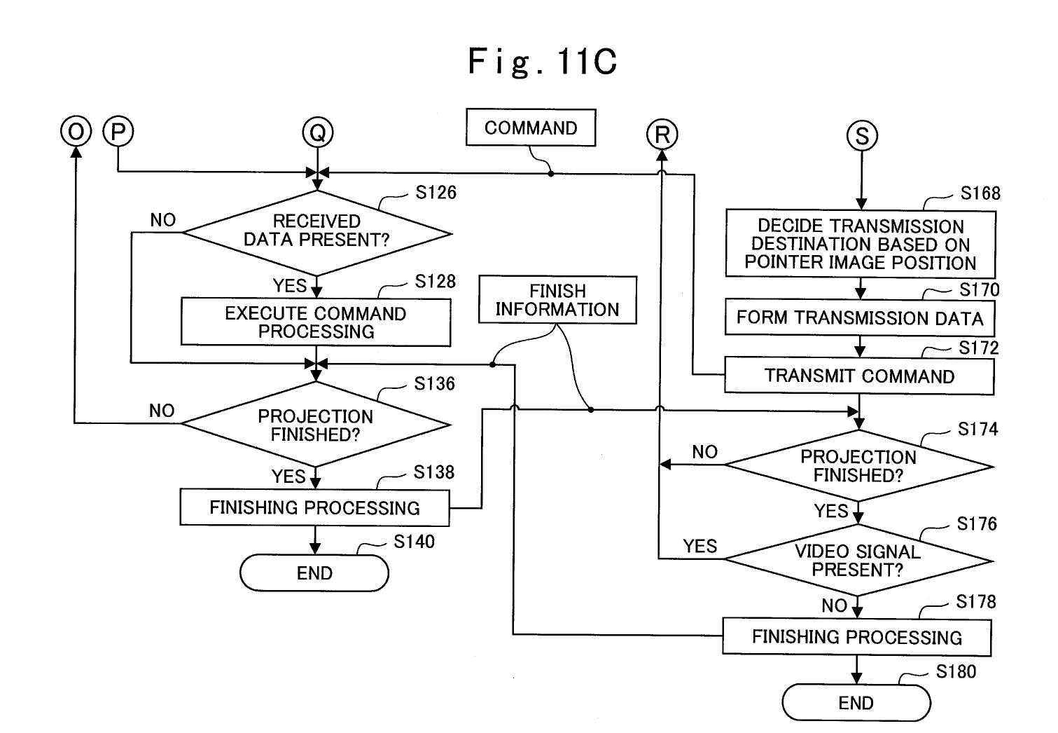

Next, another mode of operation event processing which the computer devices 800A, 800B, 800C, 800D and the projection device 100 execute is explained in conjunction with FIG. 11A to FIG. 11C.

FIG. 11A to FIG. 11C are flowcharts of operation event transmission processing which the information processing unit 880 of the computer device 800 executes and the operation event processing which the information processing unit 180 of the projection device 100 executes when a plurality of pointer images which differs in display color and shape is projected and shifted for each of the plurality of respective computer devices 800A, 800B, 800C, 800D. Here, the explanation of processing identical to the corresponding processing shown in FIG. 6A and FIG. 6B is omitted.

When a user instructs the projection of an image by operating the input unit 170 mounted on the projection device 100 or the like, the processing which the information processing unit 180 of the projection device 100 executes advances to the processing in step S152 “set projection mode and pointer mode” and sets a projection mode and a pointer mode.

Here, setting of the projection mode includes setting of a plural-image display mode in which a plurality of images acquired from a plurality of computer devices 800A, 800B, 800C, 800D is arranged in the projection image 27 which the projection device 100 projects. Once the projection mode is decided, the processing of storing various setting information such as resolution of the image received from the computer devices 800A, 800B, 800C, 800D, resolution of the projection image 27, the number or a quantity of images arranged in the projection image 27 in the RAM 181 is executed. Further, setting of the pointer mode performed in this step includes setting of pointer attributes such as the number or a quantity of pointers to be projected, a display color, a shape, a trajectory and an operation of the pointer image to be projected.

Processing in step S152 to step S154 and processing in step S102 to step S108 are identical to the corresponding processing explained in conjunction with FIG. 6A and FIG. 6B and hence, the explanation of these processing is omitted.

When the information processing unit 880 acquires a shift signal of the pointing device, a button-switch push-down signal and a button-switch push-down release signal via a bus 899 in step S108, the processing advances to processing in next step S118 “pointer image designation mode?”.

In step S118, the information processing unit 880 executes determination on whether or not a set pointer mode is a mode in which pointer attributes such as a display color, a shape, a trajectory and an operation of the pointer image 16 are designated. When the set pointer mode is not the mode which designates the pointer attributes, the processing in step S118 is branched to processing in step S122 “form transmission data”.

Further, when the set mode is a mode in which the pointer attributes are designated, the processing advances to processing in step S120 “acquire pointer attributes”, and the information processing unit 880 executes processing of reading the pointer attributes such as the display color, the shape, the trajectory and the operation of the pointer image 16 stored in the RAM 881. Then the processing advances to the processing in next step S122.

In step S122, the information processing unit 880 executes processing of forming transmission data of event information in which the operation information of the pointing device acquired in step S108, and the computer device identification information which specifies the computer devices 800A, 800B, 800C, 800D are associated with each other.

Here, the event information formed in step S122 is, for example, the information shown in FIG. 7 in which the computer device identification information and the shift signal of the pointing device are associated with each other, the display color information of the pointer image and the shift signal of the pointing device are associated with each other, or the pointer shape information and the shift signal of the pointing device are associated with each other.

Processing in step S122 to step S140 which the computer devices 800A, 800B, 800C, 800D execute is identical to the corresponding processing explained in conjunction with FIG. 6A and FIG. 6B and hence, the explanation of these processing is omitted.

On the other hand, the information processing unit 180 of the projection device 100, in step S156 “event information received?”, executes processing of waiting for the reception of the event information of the pointing device from one or a plurality of computer devices 800A, 800B, 800C, 800D via the wireless transmitting/receiving unit 161 or the wired transmitting/receiving unit 162.

When the wireless transmitting/receiving unit 161 or the wired transmitting/receiving unit 162 does not receive the event information from the computer devices 800A, 800B, 800C, 800D, the processing in step S156 is executed again. On the other hand, when the information processing unit 180 determines that the wireless transmitting/receiving unit 161 or the wired transmitting/receiving unit 162 receives the event information from the computer devices 800A, 800B, 800C, 800D, the processing advances to processing in next step S158 “specify pointer image (display color, shape, trajectory, operation and the like)”.

In step S158, the information processing unit 180 analyses the event information and executes processing of specifying the display color of the pointer image, the shape of the pointer image, the trajectory of the pointer image, the operation of the pointer and the like.

For example, when the set mode is a mode in which the pointer images which differ in display color or shape of the pointer image from each other are displayed for the respective computer devices which transmit the shift signals of the pointing devices, the pointer attributes corresponding to the computer device identification information received from the computer devices 800A, 800B, 800C, 800D are specified. Further, the pointer information such as the display color of the pointer image, or the shape of the pointer image is directly received from the computer devices 800A, 800B, 800C, 800D, the received pointer attributes are specified.

Then, the information processing unit 180 executes processing of making the pointer attributes such as the display color or the shape of the specified pointer image and the shift signal of the acquired pointing device associated with each other, and the processing advances to next step S160 “set pointer image position (Xp, Yp)”.

In step S160, the information processing unit 180 acquires a position (Xp, Yp) of the pointer image 16 having the corresponding display color or the shape from the RAM 181, and executes processing of setting a position of the pointer image 16 (Xp+ΔX→Xp, Yp+ΔY→Yp) using the shift signal (ΔX, ΔY) of the pointing device acquired in step S158.

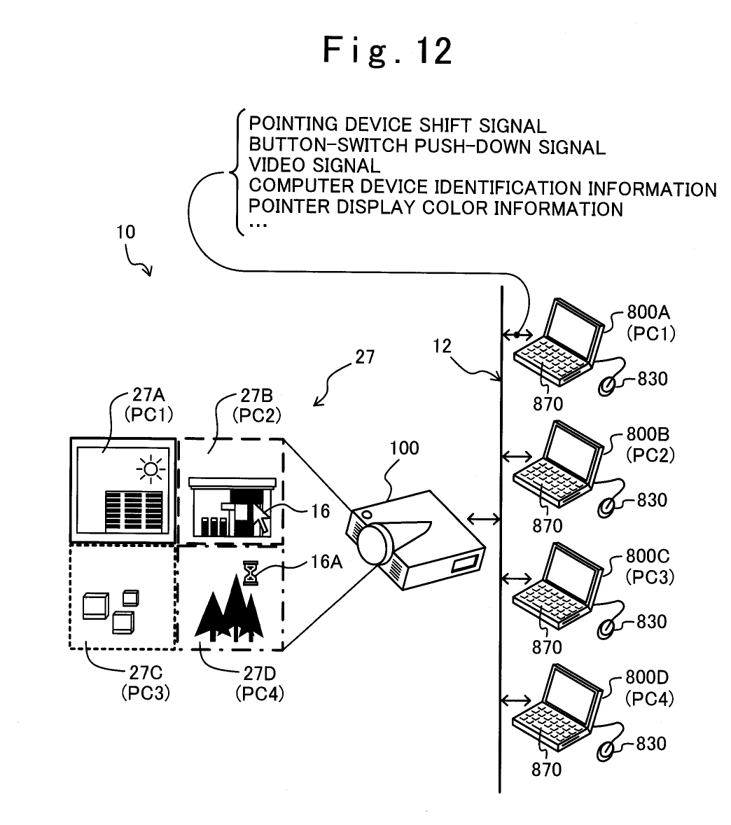

Then, in next step S162 “project projection image and pointer image”, the information processing unit 180 outputs an instruction of projecting the pointer image 16 having the display color or the shape specified in step S160 to the image processing unit 196 at the set position together with image. Then, as shown in FIG. 12, a plurality of pointer images 16, 16A is displayed on the projection image 27.

FIG. 12 shows another constitution of the projection system including the projection device according to the embodiment of the present invention.

As shown in FIG. 12, the projection system 10 projects a plurality of projection images 27A to 27D which is formed using a plurality of video signals received from a plurality of computer devices 800A, 800B, 800C, 800D in a state that the plurality of projection images 27A to 27D is arranged within one image (projection image 27).

Further, the projection system 10 projects pointer images 16, 16A which can be independently shifted based on shift signals of pointing devices received from the plurality of computer devices 800A, 800B, 800C, 800D. The pointer image 16 may be a pointer image intrinsic to the computer device 800A, for example, or a commonly-shared pointer image which is shared in common by the computer devices 800A to 800C. In shifting the commonly-shared pointer image 16, a shift signal is formed by adding a plurality of shift signals of the pointing devices acquired from the plurality of computer devices 800A to 800C to a pointer image position set by the projection device, and the commonly-shared pointer image 16 is shifted in response to such a shift signal.

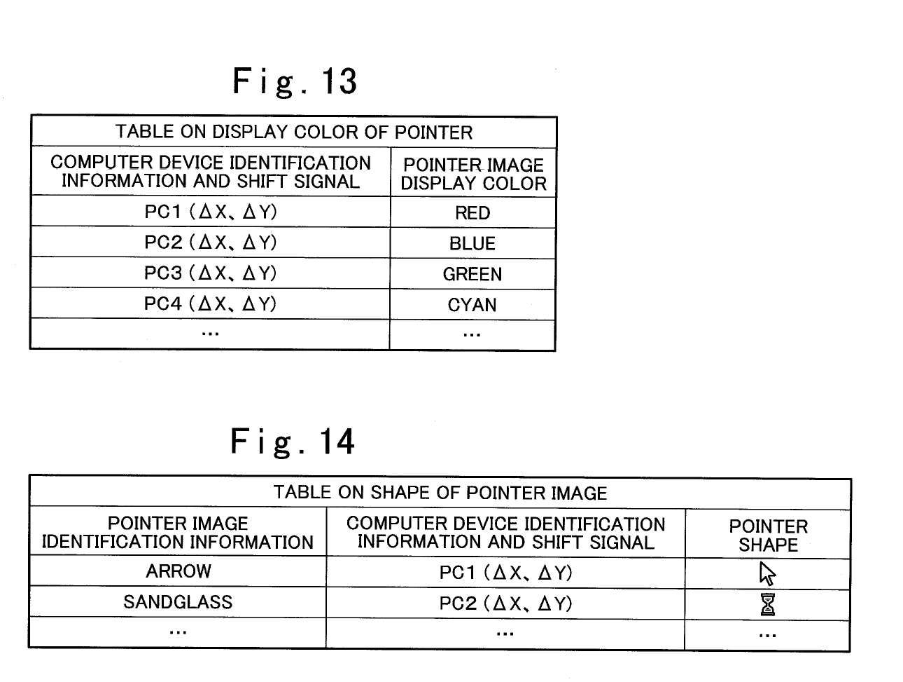

Next, a table on display colors of pointer images which makes a plurality of display colors of pointer images and the plurality of computer devices 800A (PC1) to 800D (PC4) associated with each other is explained in conjunction with FIG. 13.

FIG. 13 shows a structural example of the table on display colors of the pointer images stored in the RAM 181.

For example, in step S158, when event information in which computer device identification information and shift signals of the pointing devices are associated with each other is received from the computer devices 800A (PC1) to 800D (PC4), the image processing unit 180 executes processing of storing the event information in a state that the display color (one mode of pointer attributes) of the specified pointer image and the shift signals PC1 (ΔX, ΔY) to PC4 (ΔX, ΔY) of the pointing devices are associated with each other.

Then, in step S160, the information processing unit 180, by reference to the table shown in FIG. 13, sets a position of a new pointer image using a shift signal PC1 (ΔX, ΔY) with respect to the pointer image of red, a shift signal PC2 (ΔX, ΔY) with respect to the pointer image of blue, a shift signal PC3 (ΔX, ΔY) with respect to the pointer image of green, and a shift signal PC4 (ΔX, ΔY) with respect to the pointer image of cyan.

In this manner, the pointer images which differ from each other in display color can be projected and shifted for the plurality of respective computer devices 800A, 800B, 800C, 800D.

Next, a table on a shape of pointer images which makes a plurality of shapes of pointer images and the plurality of computer devices 800A (PC1) and 800B (PC2) associated with each other is explained in conjunction with FIG. 14.

FIG. 14 is a view showing a structural example of the table on a shape of the pointer images stored in a RAM 181.

For example, in step S158, when event information in which computer device identification information and shift signals of the pointing devices are associated with each other is received from the computer devices 800A (PC1) and 800B (PC2), processing of storing the event information in the RAM 181 is executed in a state that a shape (one mode of pointer attributes) of the specified pointer image and the shift signals PC1 (ΔX, ΔY) and PC2 (ΔX, ΔY) of the pointing devices are associated with each other.

Then, in step S160, the information processing unit 180, by reference to the table shown in FIG. 14, sets a position of a pointer image using the shift signal PC1 (ΔX, ΔY) with respect to an arrow-shaped pointer image, and the shift signal PC2 (ΔX, ΔY) with respect to an hourglass-shaped pointer image.

In this manner, the pointer images which differ from each other in a shape can be projected and shifted for the plurality of respective computer devices 800A, 800B.

Next, processing which follows processing in step S174 “projection finished?” shown in FIG. 11A to FIG. 11C is explained.

In step S174, the information processing unit 180 investigates a buffer of the wireless transmitting/receiving unit 161 or the wired transmitting/receiving unit 162, and executes the determination whether or not a command of projection finishing is transmitted from the computer device 800A, 800B, 800C, 800D. Alternatively, the information processing unit 180 investigates an interface buffer of the input unit 170, and executes the determination whether or not a command of projection finishing is acquired from a user.

When the information processing unit 180 determines that the command of projection finishing is acquired in step S174, a projection finishing flag of the computer device 800A, 800B, 800C, 800D which acquires the projection finishing is set, and processing of the erasing of the pointer image which is associated with the computer device identification information is executed. Then, the processing advances to determination in next step S176 “video signal present?”. On the other hand, when the information processing unit 180 determines that the command of projection finishing is not acquired, the processing returns to the processing in step S156.

In next step S176, the information processing unit 180 makes an inquiry to the image processing unit 196 on whether or not the video signal input unit 151 acquires a video signal. When the information processing unit 180 acquires the information that the video signal input unit 151 receives the video signal from the image processing unit 196, the processing which the information processing unit 180 executes returns to step S156, and the projection is continued.

On the other hand, when the information processing unit 180 does not acquire the information that the video signal input unit 151 receives video signal from the image processing unit 196 or the projection finishing flag of all computer devices 800A, 800B, 800C, 800D which are communicably connected with each other is set, the processing which the information processing unit 180 executes advances to processing in step S178 “finishing processing”.

In step S178, the information processing unit 180 executes processing of the output of information for finishing the projection of the projection image 27 to the lamp control circuit 195, the image processing unit 196 and the like, and finishes the projection. Then, the processing advances to next step S180 “END”, and finishes a routine of operation event processing.

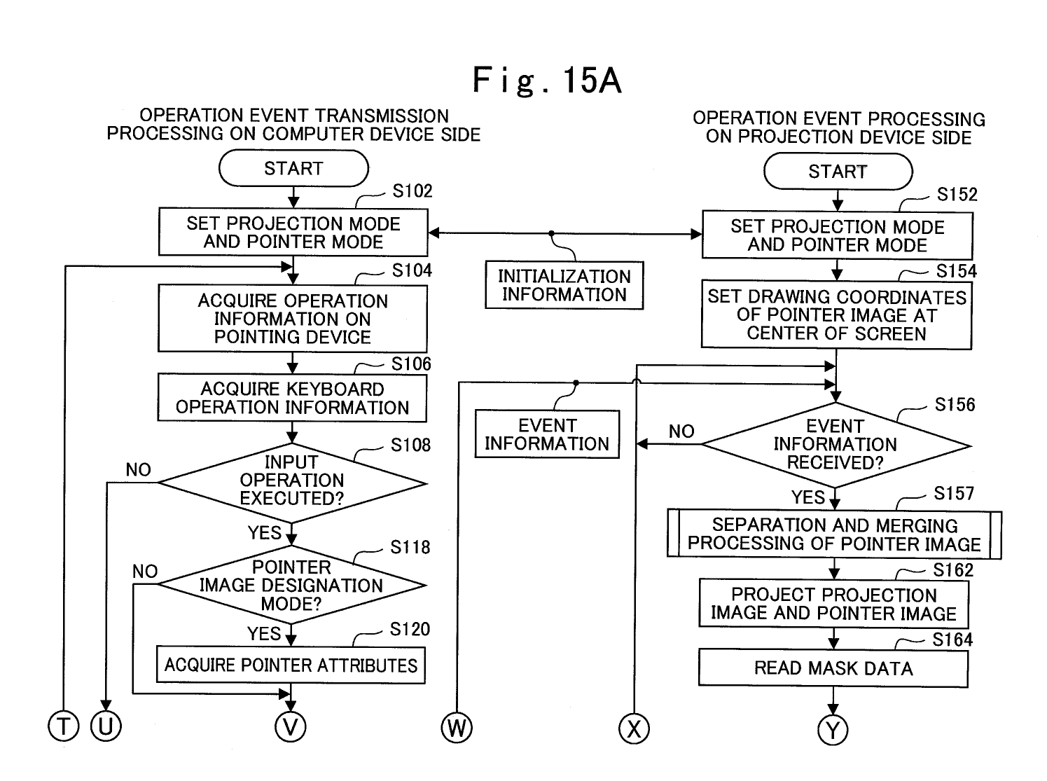

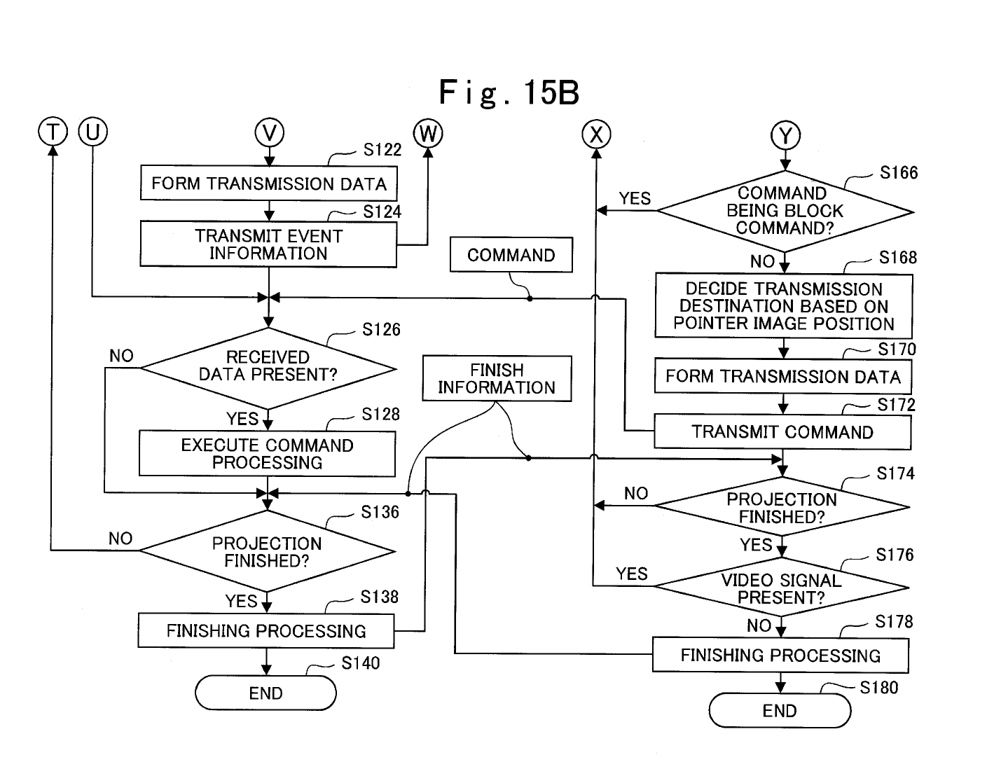

Next, another mode of operation event processing which the computer devices 800A, 800B, 800C, 800D and the projection device 100 execute is explained in conjunction with FIG. 15A and FIG. 15B.

FIG. 15A and FIG. 15B are flowcharts of processing capable of changing over a projection mode between a mode in which a dedicated pointer image is projected and a mode in which a commonly-shared pointer image is projected for a plurality of respective computer devices 800A, 800B, 800C, 800D. In the processing shown in FIG. 15A and FIG. 15B, the processing which differ from the processing shown in FIG. 11A to FIG. 11C is processing in step S157 “separation and merging processing of pointer image” which is executed on a projection device 100 side. Accordingly, the explanation of the processing identical to the corresponding processing shown in FIG. 11A to FIG. 11C is omitted by adding the same step numbers to these processing.

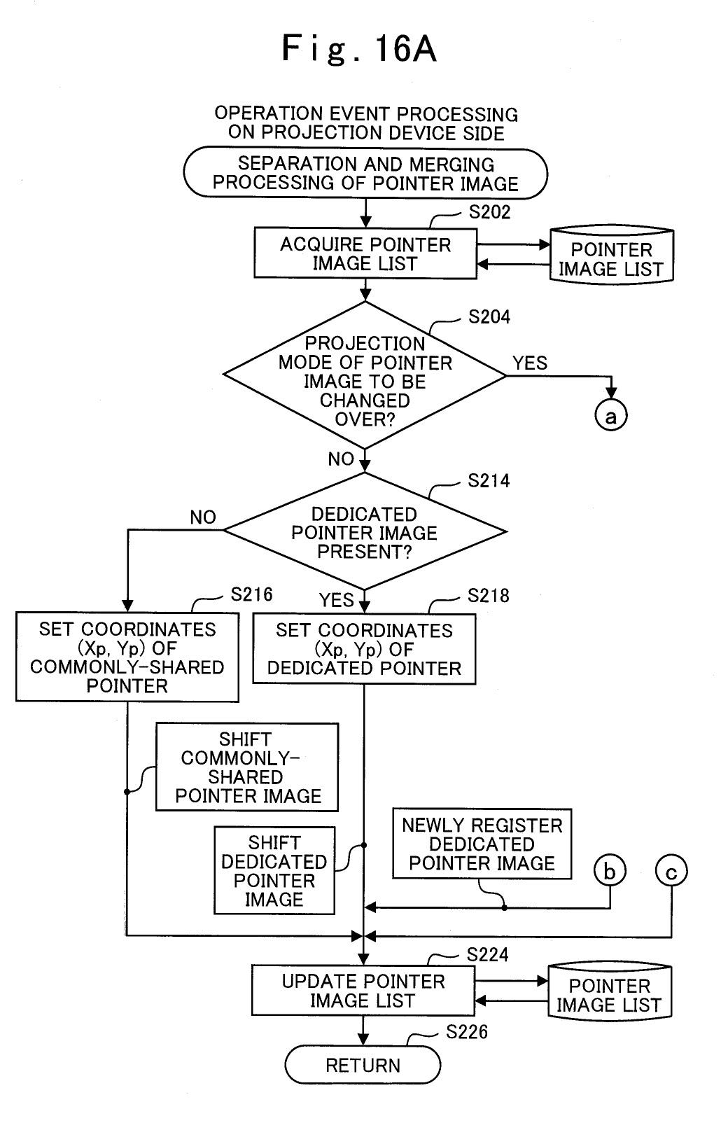

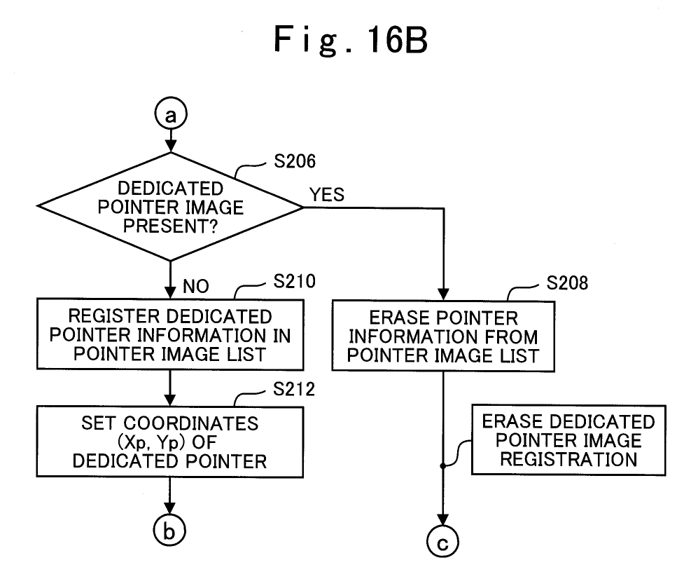

When the information processing unit 180 of the projection device 100 acquires the event information in step S156, the processing which the information processing unit 180 executes advances to a sub routine in next step S157, and the information processing unit 180 executes processing in step S202 “acquire pointer image list” shown in FIG. 16A and FIG. 16B.

FIG. 16A and FIG. 16B show the sub routine of the pointer-image separation-and-merging processing which the information processing unit 180 of the projection device 100 executes.

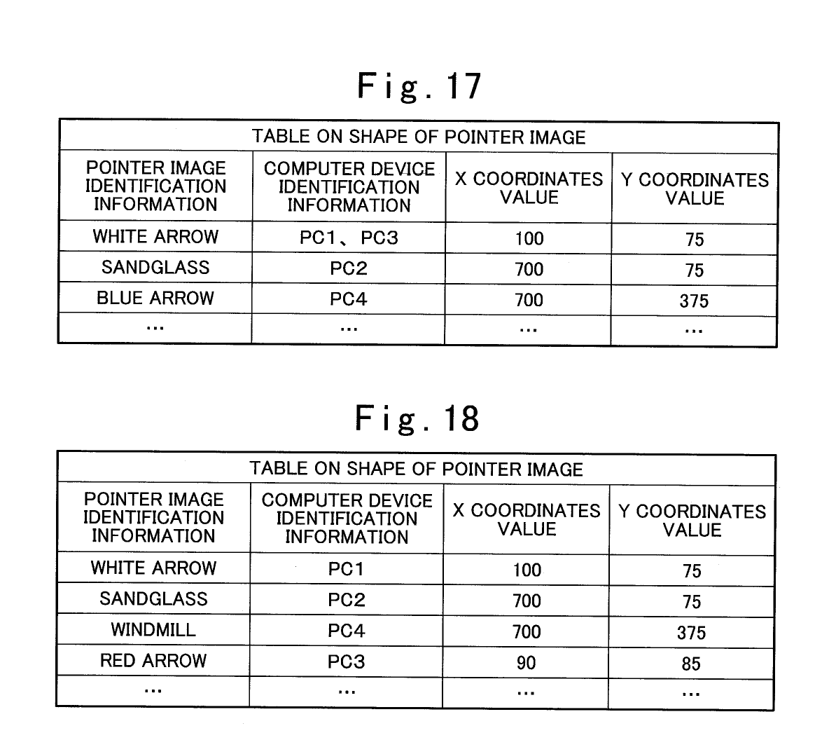

When the processing which the information processing unit 180 executes advances to step S202, the information processing unit 180 acquires a pointer image list by reference to a RAM 181. An example of the pointer image list acquired by the information processing unit 180 in this step is shown in FIG. 17.

FIG. 17 shows the example of the pointer image list which stores pointer image identification information which specifies the pointer images, computer device identification information which specifies the computer devices which acquire shift signals for shifting the respective pointer images, and coordinate values of projection positions of the respective pointer images in an associated manner.

When the pointer image list is acquired in step S202, the processing which the information processing unit 180 executes advances to determination in step S204 “projection mode of pointer image to be changed over?”. When the information processing unit 180 determines that information indicative of change over of the projection mode of the pointer image is acquired from a user in step S204, the processing is branched to determination in step S206 “dedicated pointer image present?”. On the other hand, when the information processing unit 180 determines that the information indicative of changeover of the projection mode of the pointer image is not acquired from the user, the processing advances to determination in step S214 “dedicated pointer image present?”.

As a method of inputting the information indicative of changeover of the projection mode of the pointer image acquired from the user in step S204, a method which inputs information by operating a specific switch provided to an input unit 170 of the projection device 100, a method which inputs the information by operating keyboards of the computer devices 800A, 800B, 800C, 800D which the user operates, a method which allows the user to input predetermined information to the pointing device or the like can be named.

In this embodiment, the user operates the mouse 830 which is connected with the computer device 800A, 800B, 800C, 800D and hence, the method of inputting the information indicative of changeover of the projection mode of the pointer image using such mouse 830 is explained.

For example, when the information processing unit 180 acquires a right-button-switch push-down signal of the mouse 830 which is connected with the specified computer device 800A, 800B, 800C, 800D as the event information, a flag indicative of right button-switch push-down intrinsic to the specified computer device 800A, 800B, 800C, 800D is set. Then, when the information processing unit 180 further receives a right-button-switch push-down release signal of the mouse 830, the flag indicative of the right-button-switch push-down is reset.

Next, in a state that the flag indicative of the right-button-switch push-down intrinsic to the specified computer device 800A, 800B, 800C, 800D is set (also referred to as a state in which the button-switch push-down signal of the pointing device is acquired from the specified computer device 800A, 800B, 800C, 800D), the information processing unit 180 acquires a shift signal of predetermined quantity (for example, 100 pulses) from the specified computer device 800A, 800B, 800C, 800D. When the information processing unit 180 acquires a right-button-switch push-down release signal of the mouse 830 from the specified computer device 800A, 800B, 800C, 800D thereafter, using a shift signal of the mouse 830 which is received from the specified computer device 800A, 800B, 800C, 800D, the projection device of the pointer image 16 can change over a projection state between a state in which the pointer image 16 of the mouse 830 of the specified computer device 800A, 800B, 800C, 800D is projected and shifted independently and a state in which the pointer image 16 is not projected independently.

In step S206, the information processing unit 180, by reference to the pointer image list acquired in step S202, executes determination on whether or not the pointer image identification information or the computer device identification information contained in the event information acquired in step S156 is registered as a dedicated pointer image 16. When the pointer image identification information or the computer device identification information is registered as the dedicated pointer image 16, the processing advances to step S208 “erase pointer information from pointer image list”. On the other hand, when neither the pointer image identification information nor the computer device identification information is registered as the dedicated pointer image 16, the processing advances to step S210 “register dedicated pointer information in pointer image list”.

In step S208, the information processing unit 180 executes processing of erasing dedicated pointer information associated with the pointer image identification information or the computer device identification information contained in the event information acquired in step S156 from the pointer image list acquired in step S202. Then, the processing advances to processing in step S224 “update pointer image list”.

On the other hand, in step S210, the information processing unit 180 executes processing of the registration of the dedicated pointer information associated with the pointer image identification information or the computer device identification information contained in the event information acquired in step S156, and the processing advances to processing in next step S212 “set coordinates (Xp, Yp) of dedicated pointer”. Then, for example, as an initial value of a projection position of a dedicated pointer, an initial value of a projection position (Xp, Yp) is inserted such that the dedicated pointer image is projected on the center of the projected image 27 or the position of the commonly-shared pointer image, and the initial value is stored in the RAM 181. Then, the processing advances to processing in step S224.

For example, in an example shown in FIG. 17, the pointer image which is shifted based on the shift signal received from the PC3 is the white-arrow-shaped pointer image 16 which is shared in common with the PC1. However, when information indicative of changeover of a projection mode of the pointer image of the PC3 is acquired, as shown in FIG. 18, new pointer information dedicated to the PC3 is registered. FIG. 18 shows a state in which red-arrow-shaped pointer information dedicated to the PC3 is registered in the pointer image list shown in FIG. 17.

Further, in step S214, the information processing unit 180, by reference to the pointer image list acquired in step S202, executes determination on whether or not the pointer image identification information or the computer device identification information contained in the event information acquired in step S156 is registered as a dedicated pointer image. When the pointer image identification information or the computer device identification information is registered as the dedicated pointer image, the processing advances to processing in step S218 “set coordinates (Xp, Yp) of dedicated pointer”. On the other hand, when the pointer image identification information or the computer device identification information is not registered as the dedicated pointer image, the processing advances to processing in step S216 “set coordinates (Xp, Yp) of commonly-shared pointer” in step S216.

In step S218, the information processing unit acquires the dedicated pointer information associated with the pointer image identification information or the computer device identification information contained in the event information acquired in step S156 from the pointer image list acquired in step S202, and executes processing of setting a position of the dedicated pointer image (Xp+ΔX→Xp, Yp+ΔY→Yp) using the shift signal (ΔX, ΔY) of the pointing device acquired in step S158. Then, the processing advances to processing in next step S224 “update pointer image list”.

Further, in step S216, the information processing unit 180 acquires the commonly-shared pointer information associated with the pointer image identification information or the computer device identification information contained in the event information acquired in step S156, and executes processing of setting a position of coordinates of the commonly-shared pointer (Xp+ΔX→Xp, Yp+ΔY→Yp) using the shift signal (ΔX, ΔY) of the pointing device acquired in step S158. Then, the processing advances to next step S224 “update pointer image list”. In shifting the commonly-shared pointer image, a shift signal is formed by adding the shift signals of the plurality of pointing devices acquired in association with the computer device identification information PC1 and PC3 to the pointer image position set by the projection device, and the commonly-shared pointer image 16 is shifted.

In next step S224, the information processing unit 180 executes processing of the update of the pointer image list by storing the new pointer image list in the RAM 181, and the processing advances to step S226 “RETURN” in which the processing for returning to the original processing routine shown in FIG. 15A and FIG. 15B is executed.

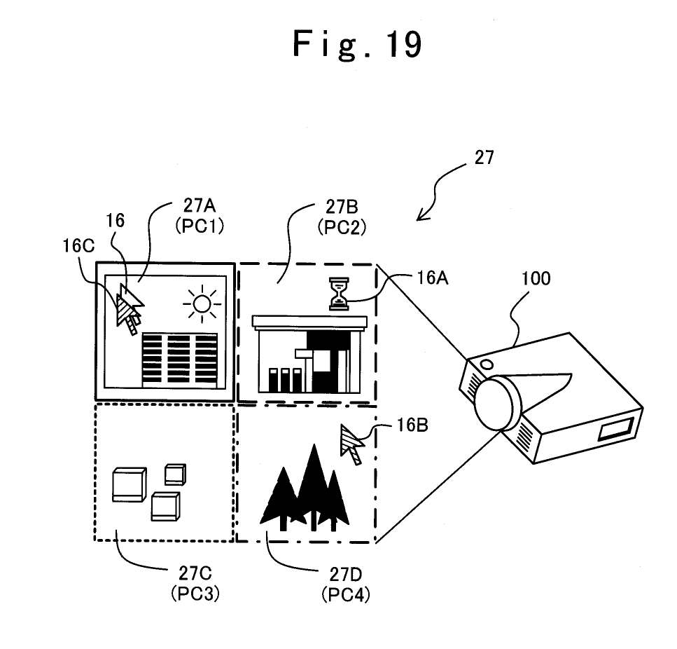

Due to such constitution, the dedicated pointer image and the commonly-shared pointer image are projected, and based on the shift signals of the pointing device acquired from the plurality of computer devices 800A to 800D, it is possible to shift the individual pointer images. Further, it is possible to changeover the projection mode between the mode in which the dedicated pointer image can be projected for each of the plurality of respective computer devices 800A to 800D and the mode in which the commonly-shared pointer image is projected. FIG. 19 shows a state in which the dedicated pointer image 16C is separated from the commonly-shared pointer image 16 by executing the above-mentioned processing in step S210 to S212.

As shown in FIG. 19, the user who operates the computer device 800C can display the new dedicated pointer image 16C by inputting the information indicative of changeover from the mode in which the commonly-shared pointer image 16 is projected to the mode in which the dedicated pointer image 16C is projected. Thereafter, the user can shift the dedicated pointer image 16C by operating the mouse 830 of the computer device 800C. Further, the user can erase the dedicated pointer image 16C by inputting the information of the changeover of the projection mode of the pointer image again, and can shift the commonly-shared pointer image 16 by operating the mouse 830 of the computer device 800C.

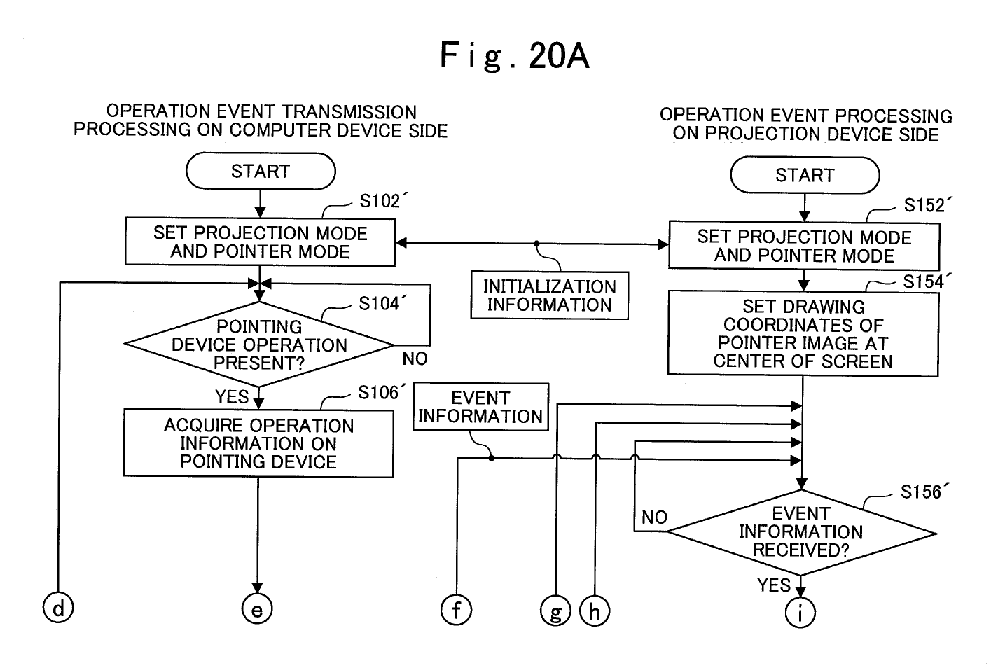

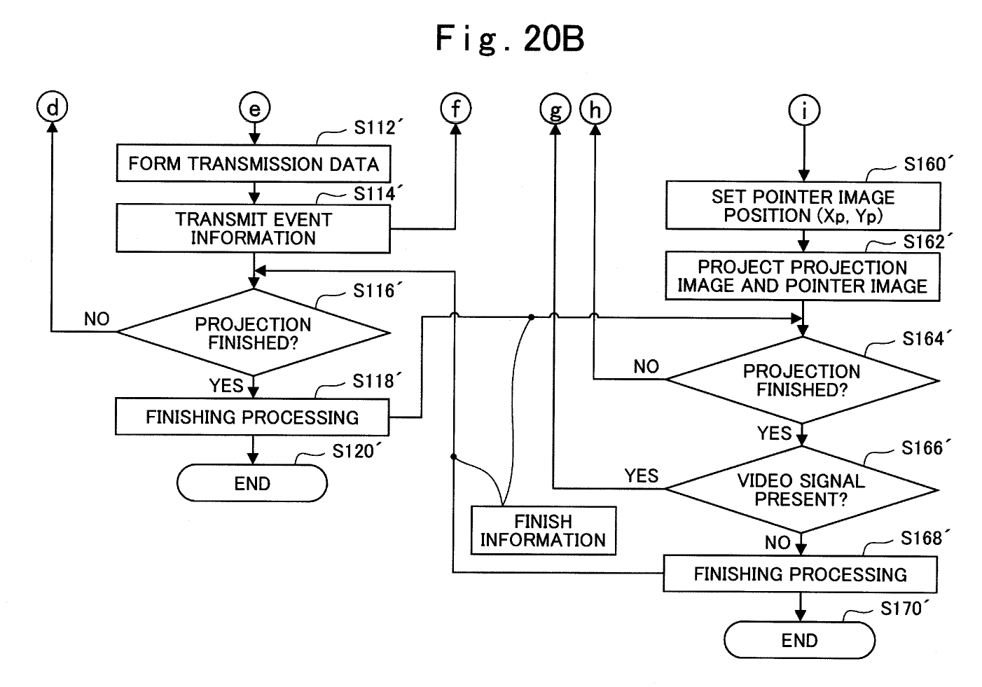

Next, another mode of the operation event processing which the computer devices 800 and the projection device 100 execute is explained in conjunction with FIG. 20A and FIG. 20B.

FIG. 20A and FIG. 20B are flowcharts of operation event transmission processing which the information processing unit 880 of the computer device 800 executes and the operation event processing which the information processing unit 180 of the projection device 100 executes.

When a user instructs the projection of an image by operating the input unit 170 mounted on the projection device 100 or the like, the processing which the information processing unit 180 of the projection device 100 executes advances to the processing in step S152′ “set projection mode and pointer mode” (hereinafter, abbreviated as step S152′) and sets a projection mode and a pointer mode.

Here, setting of the projection mode includes setting of a plurality of image display modes in which a plurality of images acquired from a plurality of computer devices is arranged in the projection image 27 which the projection device 100 projects. Once the projection mode is decided, the processing of storing various setting information such as resolution of the image received from the computer device 800, resolution of the projection image 27, the number or a quantity of images arranged in the projection image 27 in the RAM 181 is executed. Further, setting of the pointer mode performed in this step includes setting of pointer attributes such as a display color, a shape, a trajectory and an operation of the pointer image to be projected.

When the setting of the projection mode and the pointer mode is performed in step S152′, the initialization information which contains the mode setting information is stored in a memory unit such as the RAM 181 and, at the same time, the initialization information is transmitted to one or a plurality of computer devices 800 which is communicably connected with the projection device 100 via a communication unit such as the wireless transmitting/receiving unit 161 or the wired transmitting/receiving unit 162 of the projection device 100.

Then, the processing which the information processing unit 180 of the projection device 100 executes advances to step S154′ “set drawing coordinates of pointer image at center of screen”, and sets a numerical value half of number of pixels (in longitudinal and lateral directions) of the projection image 27 as an initial value of the projection position of the pointer image 16. For example, when the number of pixels of the projection image 27 is 1280 dots×1024 dots, Xp=640, Yp=512 are assigned as the initial value of the projection position (Xp, Yp) of the pointer image 16 and are stored in the RAM 181.

On the other hand, in step S102′ “set projection mode and pointer mode”, the computer device 800 receives initialization information which contains mode setting information via a communication unit such as the wireless transmitting/receiving unit 861 or the wired transmitting/receiving unit 862, stores the initialization information in the memory unit such as the RAM 881, and executes processing of setting a projection mode and a pointer mode.

Then, the information processing unit 880 executes processing of setting a mode in which the event information such as the shift signal (ΔX, ΔY) of the pointing device acquired from the mouse 830 or the like, the button-switch push-down signal and the button-switch push-down release signal are transmitted to the projection device 100 via a communication unit such as the wireless transmitting/receiving unit 861 or the wired transmitting/receiving unit 862 without transferring the event information to the application program. Here, scroll information of a wheel or the like acquired from the mouse 830 may be transferred to the application program of the computer device 800 without being transmitted to the projection device 100.

In the above-mentioned explanation, the embodiment in which setting of the projection mode and setting of the pointer mode are performed on a projection device 100 side is explained. However, the embodiment may be configured such that the setting of the projection mode and setting of the pointer mode are performed on a computer device 800 side. In this case, initialization information including mode setting information may be transmitted to the projection device 100 from the computer device 800, and setting processing of the projection mode and the pointer mode is performed on respective devices.

Further, the computer device 800A, 800B, 800C, 800D may display the pointer image 16 intrinsic to the computer device 800A, 800B, 800C, 800D by transmitting the information relating to the pointer shape or the pointer display color to the projection device 100 side. Further, with respect to the pointer shape or the pointer display color, a default pointer image 16 may be preliminarily set on the projection device 100 side. When setting of the projection mode and the pointer mode is finished in step S102′, the processing which the information processing unit 880 executes advances to the determination in next step S104′ “pointing device operation present?”, and checks a buffer of the pointing device interface 852 by interruption or polling, and executes processing of waiting for the storing of the shift signal of the pointing device, the button-switch push-down signal or the button-switch push-down release signal.

When the information processing unit 880 determines that the shift signal of the pointing device, the button-switch push-down signal or the button-switch push-down release signal is stored in the buffer of the pointing device interface 852, the processing advances to next step S106″ “acquire pointing device operation information”. On the other hand, when the information processing unit 880 determines that the shift signal of the pointing device, the button-switch push-down signal or the button-switch push-down release signal is not stored in the buffer of the pointing device interface 852, the processing returns to the processing in step S104′.

Then, in step S106′, the information processing unit 880 acquires the shift signal of the pointing device, the button switch push-down signal and the button-switch push-down release signal stored in the buffer of the pointing device interface 852 via the bus 899. Then, the information processing unit 880 executes the processing of reading the pointer attributes stored in the RAM 881 such as the display color, the shape, the trajectory, the operation and the like of the pointer image 16, and the processing advances to processing in next step S112′.

In step S112′, the information processing unit 880 executes processing of forming transmission data of event information including the operation information of the pointing device acquired in step S106′.

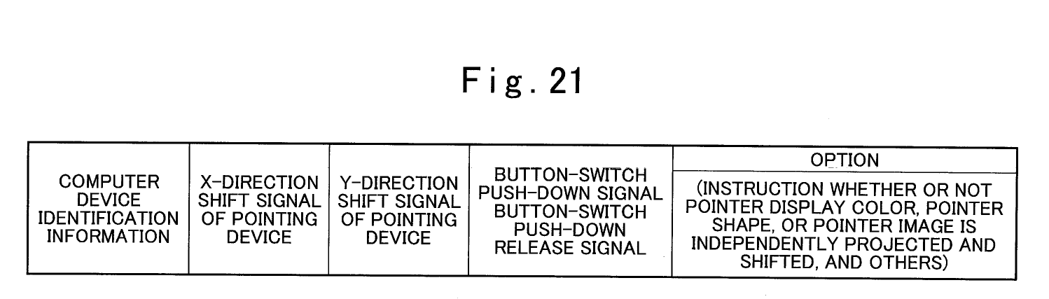

FIG. 21 shows a structural example of event information formed in step S112′.

As shown in FIG. 21, the event information contains an X-direction shift signal and a Y-direction shift signal indicative of shifting quantities of the pointing device in the X direction and in the Y direction. Further, when needed, in the processing which the projection device 100 executes, the computer device identification information and the shift signal of the pointing device may be associated with each other. Further, other information and other signals may be associated with each other as follows. That is, the display color information of the pointer image 16 and the shift signal of the pointing device may be associated with each other, the pointer shape information of the pointer image 16 and the shift signal of the pointing device may be associated with each other, the computer device identification information and the button-switch push-down signal and the button-switch push-down release signal of the pointing device or the keyboard may be associated with each other, and the computer device identification information and information on the instruction whether or not the pointer image is to be projected individually may be associated with each other.

When the formation of the transmission data of event information is finished in step S112′, the processing advances to next step S114′ “transmit event information”. In this step S112′, the information processing unit 880 outputs an address and a transmission command to the wireless transmitting/receiving unit 861 or the wired transmitting/receiving unit 862 and, at the same time, outputs event information via the bus 899. In response to such an outputting of the event information, the computer device 800 executes processing of the transmission of the event information to the projection device 100 via the wireless transmitting/receiving unit 861 or the wired transmitting/receiving unit 862. When the transmission of the event information is finished, the processing which the information processing unit 880 executes advances to the determination in step S116′ “projection finished?”.

In next step S116′, the information processing unit 880 investigates a buffer of the wireless transmitting/receiving unit 861 or the wired transmitting/receiving unit 862, and executes the determination whether or not a command of projection finishing is transmitted from the projection device 100. Alternatively, the information processing unit 880 investigates a buffer of the input interface 871, and executes the determination whether or not a command of projection finishing is acquired from a user.

When the information processing unit 880 determines that the command of projection finishing is acquired in step S116′, the processing which the information processing unit 880 executes advances to next step S118′ “finishing processing”, while when the information processing unit 880 determines that the command of projection finishing is not acquired in step S116′, the processing returns to the processing in step S104′.

In step S118′, upon reception of acquisition of the command of projection finishing, the information processing unit 880 executes processing of the release of the setting of the projection mode and a pointer mode. Then, the information processing unit 880 sets a usual-use mode in which the information processing unit 880 transfers the event information such as the shift signal (ΔX, ΔY) of the pointing device acquired from the mouse 830 or the like, the button-switch push-down signal and the button-switch push-down release signal to the application program. Then, the processing advances to next step S120′ “END” thus finishing a routine of the operation event transmission processing.

On the other hand, the information processing unit 180 of the projection device 100, in step S156′ “event information received?”, executes processing of waiting for the reception of the event information of the pointing device from one or a plurality of computer devices 800 via the wireless transmitting/receiving unit 161 or the wired transmitting/receiving unit 162.

When the event information received from the computer device 800 is not stored in a buffer of the wireless transmitting/receiving unit 161 or the wired transmitting/receiving unit 162, the information processing unit 180 further executes the processing in step S156′. On the other hand, when the information processing unit 180 further determines that the event information transmitted from the computer device 800 is stored in a buffer of the wireless transmitting/receiving unit 161 or the wired transmitting/receiving unit 162, a display color of a pointer image, a shape of the pointer image, a trajectory of the pointer image, an operation of a pointer and the like which are preliminary set are acquired from a memory unit such as the RAM 181 or the ROM 183, and the processing advances to processing in next step S160′ “set pointer image position (Xp, Yp)”.

In step S160′, the information processing unit 180 acquires a position (Xp, Yp) of the pointer image 16 which is currently set from the RAM 181, and executes processing of setting a position (Xp+ΔX→Xp, Yp+ΔY→Yp) of the pointer image 16 using the shift signal (ΔX, ΔY) of the pointing device acquired in step S156′.

Then, in next step S162′ “project projection image and pointer image”, the information processing unit 180 outputs an instruction of projecting one or a plurality of pointer images 16 specified in step S160′ at the above-mentioned set position together with the image to the image processing unit 196. Then, as shown in FIG. 1, for example, the pointer image 16 is displayed on the projection image 27. Here, the pointer image 16 may be a pointer image intrinsic to the computer device 800A, for example, or may be a commonly-shared pointer image in which one pointer image 16 is shifted based on shift signals received from a plurality of computer devices 800A, 800B, 800C, 800D. In shifting the commonly-shared pointer image 16, a shift signal (ΔX, ΔY) is formed by adding the shift signals of the plurality of pointing devices acquired from the plurality of computer devices 800A, 800B, 800C, 800D to the position of the pointer image 16 set by the projection device, and the commonly-shared pointer image 16 is shifted.

In next step S164′ “projection finished?”, the information processing unit 180 investigates a buffer of the wireless transmitting/receiving unit 161 or the wired transmitting/receiving unit 162, and executes the determination whether or not a command of projection finishing is transmitted from the computer device 800. Alternatively, the information processing unit 180 investigates an interface buffer of the input unit 170, and executes the determination whether or not a command of projection finishing is acquired from a user.

When the information processing unit 180 determines that the command of projection finishing is acquired in step S164′, a projection finishing flag of the computer device 800 which acquires the projection finishing is set, and the processing advances to determination in next step S166′ “video signal present?”. On the other hand, when the information processing unit 180 determines that the command of projection finishing is not acquired, the processing returns to step S156′.

In next step S166′, the information processing unit 180 makes an inquiry to the image processing unit 196 on whether or not the video signal input unit 151 acquires the video signal. When the information processing unit 180 acquires the information that the video signal input unit 151 receives video signal from the image processing unit 196, the processing which the information processing unit 180 executes returns to step S156′, and the projection is continued. On the other hand, when the information processing unit 180 does not acquire the information that the video signal input unit 151 receives video signal from the image processing unit 196 or the projection finishing flag of all computer devices 800 which are communicably connected with each other is set, the processing which the information processing unit 180 executes advances to processing in step S168′ “finishing processing”.

In step S168′, the information processing unit 180 executes processing of the output of information for finishing the projection of the projection image 27 to the lamp control circuit 195, the image processing unit 196 and the like, and finishes the projection. Then, the processing advances to next step S170′ “END”, and finishes a routine of operation event processing.

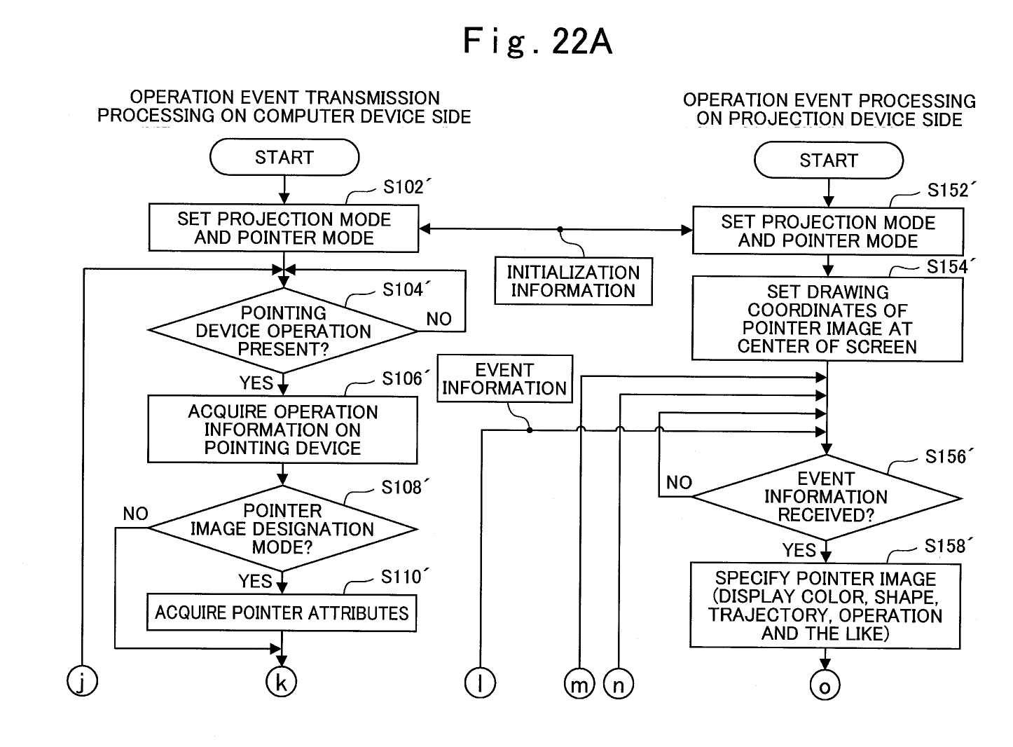

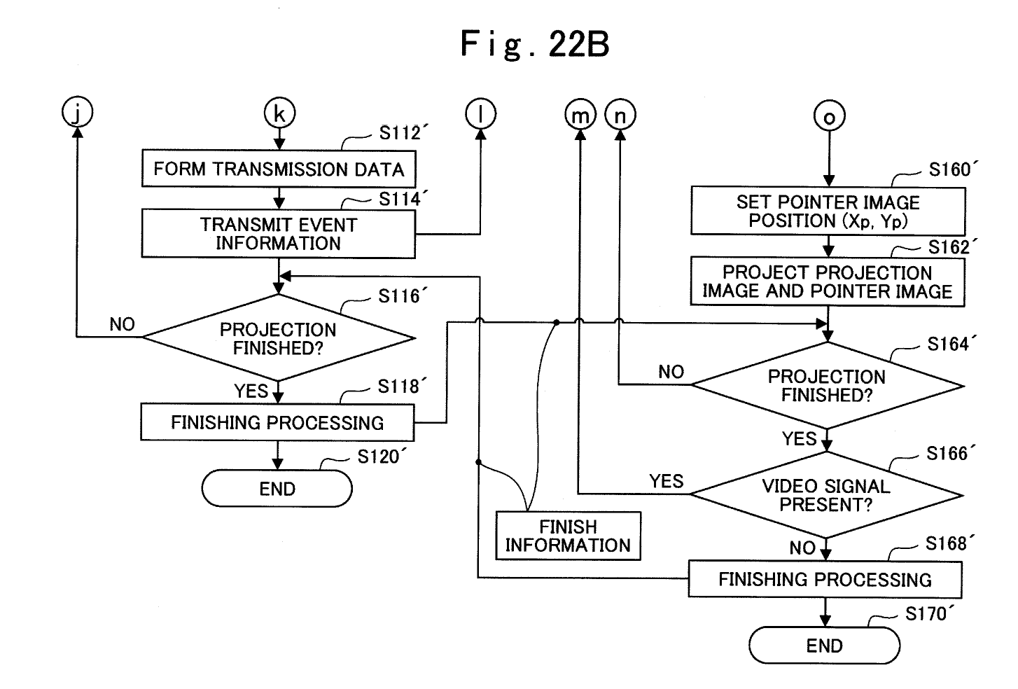

Next, another mode of operation event processing which the computer devices 800A, 800B, 800C, 800D and the projection device 100 execute is explained in conjunction with FIG. 22A and FIG. 22B.

FIG. 22A and FIG. 22B are flowcharts of operation event transmission processing which the information processing unit 880 of the computer device 800 executes and the operation event processing which the information processing unit 180 of the projection device 100 executes when a plurality of pointer images which differs in display color and shape is projected and shifted for the plurality of respective computer devices 800A, 800B, 800C, 800D. Here, the explanation of processing identical to the corresponding processing shown in FIG. 20A and FIG. 20B is omitted.

When a user instructs the projection of an image by operating the input unit 170 mounted on the projection device 100 or the like, the processing which the information processing unit 180 of the projection device 100 executes advances to the processing in step S152′ “set projection mode and pointer mode” and sets a projection mode and a pointer mode.

Here, setting of the projection mode includes setting of a plural-image display mode in which a plurality of images acquired from a plurality of computer devices is arranged in the projection image 27 which the projection device 100 projects. Once the projection mode is decided, the processing of storing various setting information such as resolution of the image received from the computer devices 800A, 800B, 800C, 800D, resolution of the projection image 27, the number or a quantity of images arranged in the projection image 27 in the RAM 181 is executed. Further, setting of the pointer mode performed in this step includes setting of pointer attributes such as the number or a quantity of pointers to be projected, a display color, a shape, a trajectory and an operation of the pointer image to be projected.

Processing in step S152′ to step S154′ and processing in step S102′ to step S106′ are identical to the corresponding processing explained in conjunction with FIG. 20A and FIG. 20B and hence, the explanation of these processing is omitted.

When the information processing unit 880 acquires a shift signal of the pointing device, a button-switch push-down signal and a button-switch push-down release signal via a bus 899 in step S106′, the processing advances to processing in next step S108′ “pointer image designation mode?”.

In step S108′, the information processing unit 880 executes determination on whether or not a set pointer mode is a mode in which pointer attributes such as a display color, a shape, a trajectory and an operation of the pointer image are designated. When the set pointer mode is not the mode which designates the pointer attributes, the processing in step S108′ is branched to processing in step S112′ “form transmission data”.

Further, when the set mode is a mode in which the pointer attributes are designated, the processing advances to processing in step S110′ “acquire pointer attributes”, and the information processing unit 880 executes processing of reading the pointer attributes such as the display color, the shape, the trajectory and the operation of the pointer image 16 stored in the RAM 881. Then the processing advances to the processing in next step S112′.

In step S112′, the information processing unit 880 executes processing of forming transmission data of event information in which the operation information of the pointing device acquired in step S106′, and the computer device identification information which specifies the computer devices 800A, 800B, 800C, 800D are associated with each other.

Here, the event information formed in step S112′ is, for example, the information shown in FIG. 21 in which the computer device identification information and the shift signal of the pointing device are associated with each other, the display color information of the pointer image and the shift signal of the pointing device are associated with each other, or the pointer shape information and the shift signal of the pointing device are associated with each other.

Processing in step S112′ to step S120′ which the computer devices 800A, 800B, 800C, 800D execute is identical to the corresponding processing explained in conjunction with FIG. 20A and FIG. 20B and hence, the explanation of these processing is omitted.

On the other hand, the information processing unit 180 of the projection device 100, in step S156′ “event information received?”, executes processing of waiting for the reception of the event information of the pointing device from one or a plurality of computer devices 800A, 800B, 800C, 800D via the wireless transmitting/receiving unit 161 or the wired transmitting/receiving unit 162.

When the wireless transmitting/receiving unit 161 or the wired transmitting/receiving unit 162 does not receive the event information from the computer devices 800A, 800B, 800C, 800D, the processing in step S156′ is executed again. On the other hand, when the information processing unit 180 determines the wireless transmitting/receiving unit 161 or the wired transmitting/receiving unit 162 receives the event information from the computer devices 800A, 800B, 800C, 800D, the processing advances to processing in next step S158′ “specify pointer image (display color, shape, trajectory, operation and the like)”.

In step S158′, the information processing unit 180 executes processing of analyzing the event information and specifying the display color of the pointer image, the shape of the pointer image, the trajectory of the pointer image, the operation of the pointer or the like.

For example, when the set mode is a mode in which the pointer images which differ in display color or shape of the pointer image from each other are displayed for the respective computer devices which transmit the shift signals of the pointing devices, the pointer attributes corresponding to the computer device identification information received from the computer devices 800A, 800B, 800C, 800D are specified. Further, the pointer information such as the display color of the pointer image, or the shape of the pointer image is directly received from the computer devices 800A, 800B, 800C, 800D, the received pointer attributes are specified.

Then, the information processing unit 180 executes processing of making the pointer attributes such as the display color or the shape of the specified pointer image and the shift signal of the acquired pointing device associated with each other, and the processing advances to processing in next step S160′ “set pointer image position (Xp, Yp)”.

In step S160′, the information processing unit 180 acquires a position (Xp, Yp) of the pointer image 16 having the corresponding display color or the shape from the RAM 181, and executes processing of setting a position of the pointer image 16 (Xp+ΔX→Xp, Yp+ΔY→Yp) using the shift signal (ΔX, ΔY) of the pointing device acquired in step S158′.

In the above-mentioned mode, the position of the pointer image 16 is set by acquiring the relative shift quantity (ΔX, ΔY) from the computer device 800A, 800B, 800C, 800D. However, the projection device 100 may set the position of the pointer image 16 by acquiring an absolute position (Xp, Yp) of the pointer image 16 from the computer device 800A, 800B, 800C, 800D.

Then, in next step S162′ “project projection image and pointer image”, the information processing unit 180 outputs an instruction of projecting the pointer image 16 having the display color or the shape specified in step S160′ to the image processing unit 196 at the set position together with image. Then, as shown in FIG. 12, a plurality of pointer images 16, 16A is displayed on the projection image 27.

Next, processing which follows processing in step S164′ “projection finished?” shown in FIG. 22A and FIG. 22B is explained.

In step S164′, the information processing unit 180 investigates a buffer of the wireless transmitting/receiving unit 161 or the wired transmitting/receiving unit 162, and executes the determination whether or not a command of projection finishing is transmitted from the computer device 800A, 800B, 800C, 800D. Alternatively, the information processing unit 180 investigates an interface buffer of the input unit 170, and executes the determination whether or not a command of projection finishing is acquired from a user.

When the information processing unit 180 determines that the command of projection finishing is acquired in step S164′, a projection finishing flag of the computer device 800A, 800B, 800C, 800D which acquires the projection finishing is set, and processing of erasing the pointer image which is associated with the computer device identification information is executed. Then, the processing advances to determination in next step S166′ “video signal present?”. On the other hand, when the information processing unit 180 determines that the command of projection finishing is not acquired, the processing returns to the processing in step S156′.

In next step S166′, the information processing unit 180 makes an inquiry to the image processing unit 196 on whether or not the video signal input unit 151 acquires the video signal. When the information processing unit 180 acquires the information that the video signal input unit 151 receives video signal from the image processing unit 196, the processing which the information processing unit 180 executes returns to step S156′, and the projection is continued.

On the other hand, when the information processing unit 180 does not acquire the information that the video signal input unit 151 receives video signal from the image processing unit 196 or the projection finishing flag of all computer devices 800A, 800B, 800C, 800D which are communicably connected with each other is set, the processing which the information processing unit 180 executes advances to processing in step S168′ “finishing processing”.

In step S168′, the information processing unit 180 executes processing of the output of information for finishing the projection of the projection image 27 to the lamp control circuit 195, the image processing unit 196 and the like, and finishes the projection. Then, the processing advances to next step S170′ “END”, and finishes a routine of operation event processing.

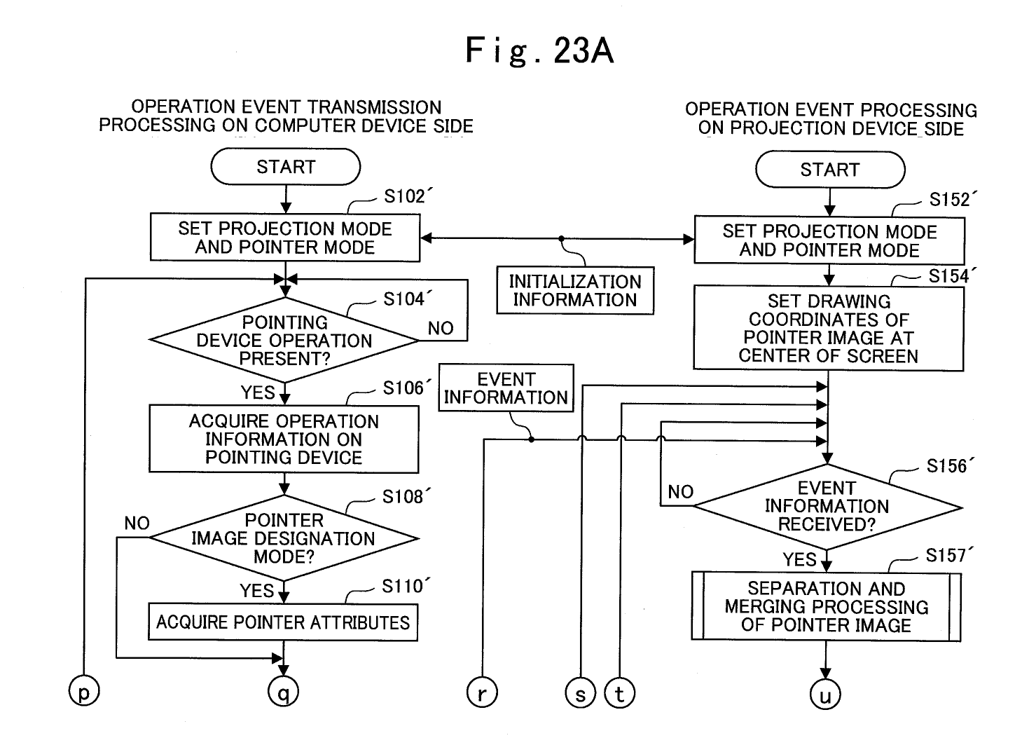

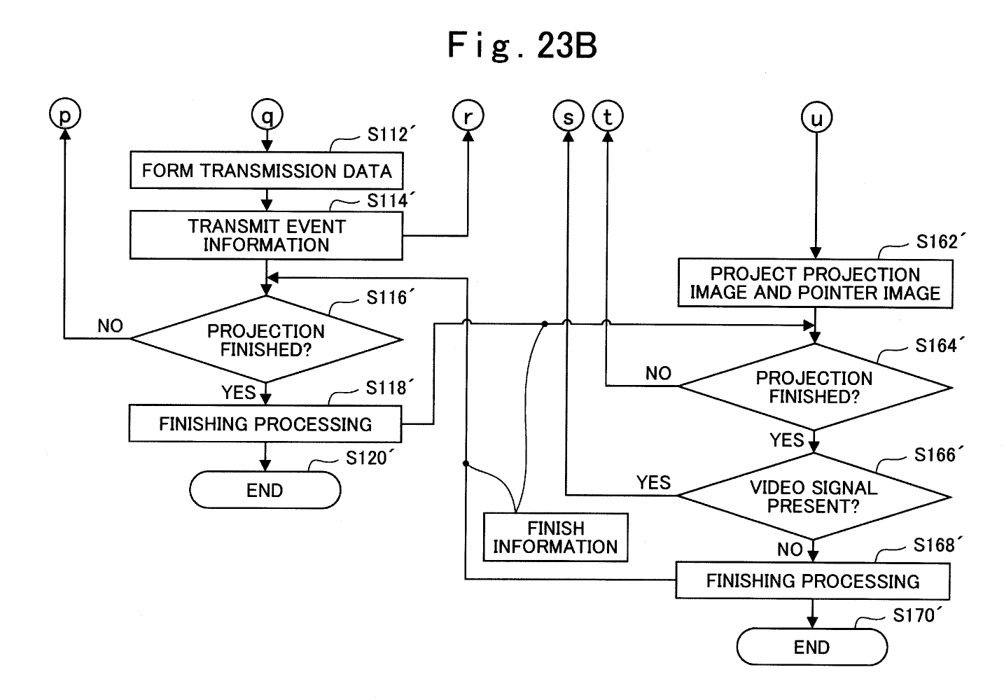

Next, another mode of operation event processing which the computer devices 800A, 800B, 800C, 800D and the projection device 100 execute is explained in conjunction with FIG. 23A and FIG. 23B.

FIG. 23A and FIG. 23B are flowcharts of processing capable of changing over a mode in which a dedicated pointer image is projected and a mode in which a commonly-shared pointer image is projected for the plurality of respective computer devices 800A to 800D. With respect to the processing shown in FIG. 23A and FIG. 23B, processing which differs from the processing shown in FIG. 22A and FIG. 22B is processing in step S157′ “separation and merging processing of pointer image” which is executed on the projection device 100 side. Accordingly, the explanation of the processing identical to the processing shown in FIG. 22A and FIG. 22B is omitted by giving the same step numbers.

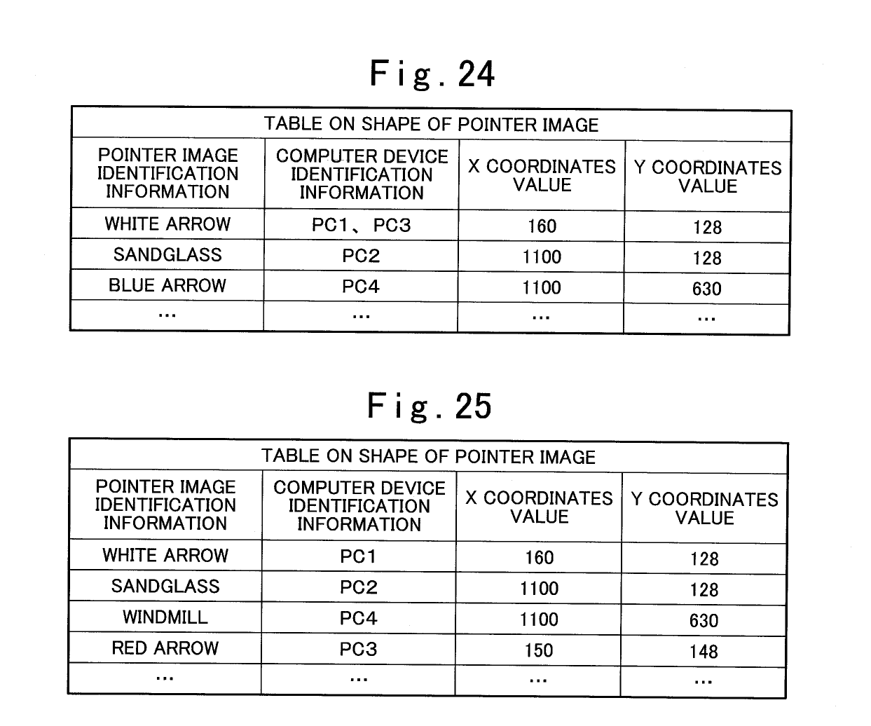

When the information processing unit 180 of the projection device 100 acquires the event information in step S156′, the processing which the information processing unit 180 executes advances to a sub routine in step S157′, and the information processing unit 180 executes the pointer image separation/merging processing shown in FIG. 16A and FIG. 16B. In step S202 “acquire pointer image list”, the information processing unit 180 acquires the pointer image from the list shown in FIG. 24 and the list shown in FIG. 25.

In an example shown in FIG. 24, the pointer image which is shifted based on the shift signal received from the PC3 is the white arrow-shaped pointer image shared in common with the PC1. However, when the information processing unit 180 acquires information indicative of the changeover of the projection mode of the pointer image of the PC3, as shown in FIG. 25, new pointer information dedicated to the PC3 is registered. Here, FIG. 25 shows a state in which the red arrow-shaped pointer information dedicated to the PC3 is registered in the pointer image list shown in FIG. 24. Thereafter, processing identical to the processing in step S164′ shown in FIG. 22A and FIG. 22B and processing in subsequent drawings are executed.

What is claimed is:

1. A projection device comprising:
a receiving unit which is configured to receive command signals of input devices which are connected with a plurality of computer devices from said plurality of respective computer devices;
a pointer image forming unit which is configured to form pointer images of the input devices;
a pointer image position setting unit which is configured to set pointer image positions based on the command signals received from the input devices; and
a projection unit which is configured to project an image including at least the pointer images at the pointer image positions set by the pointer image position setting unit.

2. A projection device according to claim 1, wherein the input device includes a pointing device which is connected with the computer device,
the command signal contains a shift signal which is generated by the pointing device,
the projection device further comprises a shift signal adding unit which is configured to generate a new shift signal by adding the shift signals from the plurality of computer devices to a pointer image position set in the projection device, and the pointer image position setting unit is configured to set the pointer image position based on the generated shift signal.

3. A projection device according to claim 2, wherein the receiving unit is configured to receive computer device identification information for identifying the plurality of respective computers and shift signals of the pointing devices which are connected with the computer devices from the plurality of respective computer devices in a state that the computer device identification information and the shift signals are associated with each other,
the pointer image forming unit is configured to specify display colors of the pointer images corresponding to the received computer device identification information and is configured to associate the display colors of the pointer images with the shift signals,
the pointer image position setting unit is configured to set the positions of the pointer images of the display colors which are associated with the shift signals based on the received shift signals of the pointing devices, and
the projection unit is configured to project the pointer images of the specified display colors to the set positions.

4. A projection device according to claim 2, wherein the receiving unit receives display color information of the pointer images and the shift signals of the pointing devices which are connected with the computer devices from the plurality of respective computer devices in a state that the display color information and the shift signals are associated with each other,
the pointer image forming unit is configured to specify the display colors of the pointer images in accordance with the display color information of the received pointer images and is configured to associate the specified display colors with the shift signals,
the pointer image position setting unit is configured to set the positions of the pointer images of the display colors which are associated with the shift signals based on the received shift signals of the pointing devices, and
the projection unit is configured to project images which contain at least the pointer images of the specified display colors to the set positions.

5. A projection device according to claim 2, wherein the receiving unit is configured to receive computer device identification information which identifies the plurality of respective computer devices and shift signals of the pointing devices which are connected with the computer devices from the plurality of respective computer devices in a state that the computer device identification information and the shift signals are associated with each other,
the pointer image forming unit is configured to specify shapes of the pointers corresponding to the received computer device identification information and is configured to make the shapes of the pointers associated with the shift signals,
the pointer image position setting unit is configured to set the positions of the pointer images of the shapes which are associated with the shift signals based on the received shift signals of the pointing devices, and
the projection unit is configured to project an image at least including the pointer images of the specified shapes to the set positions.

6. A projection device according to claim 2, wherein the receiving unit is configured to receive pointer shape information and the shift signals of the pointing devices which are connected with the plurality of computer devices from the plurality of respective computer devices in a state that the pointer shape information and the shift signals are associated with each other,
the pointer image forming unit is configured to specify shapes of the pointers corresponding to the received pointer shape information and is configured to associate the shapes of the pointers with the shift signals,
the pointer image position setting unit is configured to set the positions of the pointer images of the shapes which are associated with the shift signals based on the received shift signals of the pointing devices, and
the projection unit is configured to project an image including at least the pointer images of the specified shapes to the set positions.

7. A projection device according to claim 2, wherein the projection device includes:
a video signal receiving unit which is configured to receive a plurality of video signals from the plurality of computer devices; and
an image arranging unit which arranges a plurality of images formed based on the plurality of received video signals within one image, and
the projection unit is configured to project the image in which the plurality of images is arranged together with the pointer images.

8. A projection device according to claim 2, wherein the receiving unit is configured to receive shift signals of the pointing devices which are connected with specified computer devices and other computer devices excluding the specified computer devices from the specified computer devices and other computer devices excluding the specified computer devices,
the pointer image forming unit is configured to form the plurality of pointer images of the pointing devices,
the pointer image position setting unit is configured to set a position of a first pointer image based on the shift signal generated by adding the shift signals from the plurality of computer devices to the pointer image position set in the projection device, and is configured to set a position of a second pointer image based on the received shift signal of the pointing device of the specified computer device, and
the projection unit is configured to project an image which contains at least the plurality of pointer images to the set positions.

9. A projection device according to claim 2, wherein the projection device further includes:
a pointer projection instruction acquisition unit which is configured to acquire an instruction whether or not the pointer image for the pointing device is independently projected and shifted using the shift signal of the pointing device received from the specified computer device; and
a shift signal adding unit which is configured to generate a shift signal by adding the shift signals of a plurality of pointing devices to the pointer image position set by the projection device,
the pointer image forming unit is configured to form one or a plurality of pointer images of the pointing devices,
the receiving unit is configured to receive the shift signals of the pointing devices which are connected with the specified computer device and other computer devices excluding the specified computer device from the specified computer device and other computer devices excluding the specified computer device,
when the pointer projection instruction acquiring unit acquires an instruction indicative of not independently projecting the pointer image for the pointing device using the shift signal received from the specified computer device, the shift signal adding unit generates a shift signal by adding the shift signals received from the specified computer device and said other computer devices to the pointer image position set by the projection device, and the pointer image position setting unit sets the pointer image position based on the generated shift signal, and the projection unit projects an image including the pointer image to at least the set position, and
when the pointer projection instruction acquiring unit receives an instruction indicative of independently projecting and shifting the pointer image of the pointing device using the shift signal of the pointing device received from the specified computer device, the shift signal adding unit generates a shift signal by adding shift signals received from said other computer devices to the pointer image position set in the projection device, the pointer image position setting unit sets a position of a first pointer image based on the generated shift signal, a second pointer image is set based on the received shift signal of the pointing device of the specified computer device, and the projection unit projects an image which contains a plurality of pointer images to at least the set position.

10. A projection device according to claim 9, wherein the receiving unit is configured to receive button push-down signals and button push-down release signals of the pointing devices which are connected with the plurality of computer devices from the plurality of computer devices, and
the pointer projection instruction acquiring unit is configured to acquire the shift signal of a predetermined quantity in a state that button push-down signal of the pointing device is acquired from the specified computer device and, thereafter, when a button push-down release signal of the pointing device is acquired, a pointer image shift state is changed over between a state in which the pointer image for the pointing device is independently projected and shifted using the shift signal of the pointing device received from the specified computer device and a state in which the pointer image is not independently projected.

11. A projection device according to claim 1, wherein the projection device further includes:
a video signal receiving unit which is configured to receive one or a plurality of video signals from one or the plurality of computer devices;
an image arranging unit which is configured to synthesize and arrange one or the plurality of images which are formed from the received one or plurality of video signals within a region of one image;
an image region identification information generating unit which is configured to generate computer device identification information which specifies the computer device which outputs the images and image region identification information which associates the region in which said one or plurality of images are arranged and the computer device identification information with each other;
a projection unit which is configured to project said one or plurality of images which are synthesized and arranged within the region of said one image and the pointer image which is set at the position set by the pointer image position setting unit;
a computer device specifying unit which is configured to specify the computer device which outputs the image indicative of the pointer image from the projection position of the pointer image set at the position and the image region identification information; and
a transmitting unit which is configured to transmit a specified command signal corresponding to a projection position of the set pointer image to the specified computer device based on the received command signal of the input device.

12. A projection device according to claim 11, wherein the input device includes pointing devices which are connected with the computer devices, and the command signal contains a shift signal which is generated by the pointing device.

13. A projection device according to claim 12, wherein the input device includes a keyboard which is connected with the computer device,
the command signal contains a button push-down signal which is generated by the pointing device or the keyboard, and
the specified command signal contains the shift signal and the button push-down signal of the pointer image displayed on the specified computer device.

14. A projection device according to claim 12, wherein the image arranging unit is configured to arrange said one or plurality of images within the region of said one image by adjusting sizes of the images received from the plurality of computer devices and is configured to acquire sizes of the images after adjustment for the respective computer devices, and
the transmitting unit is configured to transmit the specified command signal to the specified computer device in a state that the specified command signal and the size of the image after adjustment are associated with each other.

15. A projection device according to claim 14, wherein the projection device further includes:
a mask data storing unit which is configured to store mask data for masking the predetermined signals for button push-down signals of the keyboard contained in the command signal or the combination of the push-down signals; and
a filter unit which is configured to compare button push-down signals of the keyboard contained in the command signal or the combination of push-down signals and the mask data, and is configured to select the button push-down signals or the combination of the button push-down signals which do not correspond to the mask data, wherein
the transmitting unit is configured to transmit the selected button push-down signals or the combination of the selected button push-down signals to the specified computer device as the specified command signals.

16. A computer-readable recording medium recording a program executed by an information processing unit of a projection device which includes: a receiving unit which is configured to receive command signals of input devices from a plurality of computer devices; a video signal receiving unit which is configured to receive video signals from the plurality of computer devices; an image arranging unit which is configured to synthesize and arrange one or a plurality of images within a region of one image; an image region identification information generating unit which is configured to generate image region identification information in which the region of the image and computer device identification information are associated with each other; a pointer image forming unit which is configured to form a pointer image arranged within the region of said one image; a pointer image position setting unit which is configured to set a pointer image position based on a command signal of the input device; a projection unit which is configured to project said one or plurality of images which are synthesized and arranged at a predetermined position within said one image and the pointer image; a computer device specifying unit which is configured to specify the computer device which outputs a predetermined video signal; a transmitting unit which is configured to transmit a corresponding command which corresponds to a projection position of the set pointer image for the specified computer device; and the information processing unit which is capable of controlling the receiving unit, the video signal receiving unit, the image arranging unit, the image region identification information generating unit, the pointer image forming unit, the pointer image position setting unit, the projection unit, the computer device specifying unit, and the transmitting unit, wherein
the program is executed by the information processing unit such that:
the receiving unit performs a function of receiving the command signals of the input devices which are connected with the plurality of computer devices from the plurality of computer devices,
the video signal receiving unit performs a function of receiving said one or plurality of video signals from said one or plurality of computer devices,
the image arranging unit performs a function of synthesizing and arranging said one or plurality of video signals generated based on the received one or plurality of video signals within the region of said one image,
the image region identification information generating unit performs a function of generating computer device identification information which specifies computer device which outputs the image, and image region identification information which associates said one region in which one or a plurality of images are arranged and the computer device identification information with each other,
the pointer image forming unit performs a function of forming the pointer image which is arranged within the region of said one image,
the pointer image position setting unit performs a function of setting a position of the pointer image based on the received command signal,
the projection unit performs a function of projecting said one or plurality of images which are synthesized and arranged within the region of said one image, and the pointer image which is set at the position,
the computer device identifying unit performs a function of specifying the computer devices which output an image pointed out by the pointer image from the projection position of the pointer image set at the position and the image region identification information, and
the transmitting unit performs a function of transmitting specified command signal corresponding to the set projection position of the pointer image to the specified computer device based on the received command signal of the input device.

17. A projection method of an image using a projection device which includes:
a receiving unit which is configured to receive command signals of input devices from a plurality of computer devices;
a video signal receiving unit which is configured to receive video signals from the plurality of computer devices;
an image arranging unit which is configured to synthesize and arrange one or a plurality of images within a region of one image;
an image region identification information generating unit which is configured to generate image region identification information in which the region of the image and computer device identification information are associated with each other;
a pointer image forming unit which is configured to form a pointer image arranged within the region of said one image;
a pointer image position setting unit which is configured to set a pointer image position based on a command signal of the input device;
a projection unit which is configured to project said one or plurality of images which are synthesized and arranged at a predetermined position within the region of said one image and the pointer image;
a computer device specifying unit which is configured to specify the computer device which outputs a predetermined video signal; and
a transmitting unit which is configured to transmit a corresponding command which corresponds to a projection position of the set pointer image to the specified computer device,
the projection method of an image comprising the steps of:
receiving the command signals of the input devices which are connected with the plurality of computer devices from the plurality of computer devices;
receiving said one or plurality of video signals from said one or plurality of computer devices;
synthesizing and arranging said one or plurality of video signals generated based on received one or plurality of video signals within a region of one image;
generating computer device identification information which specifies computer device which outputs the image, and image region identification information which associates said one region in which one or a plurality of images are arranged and the computer device identification information with each other;
forming the pointer image which is arranged within the region of said one image;
setting a position of the pointer image based on the received command signal,
projecting said one or plurality of images which are synthesized and arranged within the region of said one image, and the pointer image which is set at the position,
specifying the computer device which outputs an image which is pointed out by the pointer image from the projection position of the pointer image set at the position and the image region identification information, and
transmitting a specified command signal corresponding to the set projection position of the pointer image to the specified computer device based on the received command signal of the input device.

18. A projection system comprising:
a plurality of computer devices with which input devices are connected; and
a projection device which is configured to receive video signals from the plurality of computer devices and command signals of the input devices and is configured to project an image and a pointer image within a region of one image, wherein
said each computer device includes:
a) a command signal transmitting unit which is configured to output the command signal of the input device to the projection device;
b) a video signal transmitting unit which is configured to output the video signal of the image to be displayed based on an application program to the projection device;
c) a command signal receiving unit which is configured to receive a specified command signal generated based on the command signal of the input device from the projection device; and
d) a shift signal transferring unit which is configured to transfer the received specified command signal to the application program; and
a projection device includes:
a) a receiving unit which is configured to receive command signals of input devices which are connected with a plurality of computer devices from the plurality of respective computer devices;
b) a video signal receiving unit which is configured to receive one or a plurality of video signals from one or the plurality of computer devices;
c) an image arranging unit which is configured to synthesize and arrange one or a plurality of images formed based on the received one or plurality of video signals within a region of one image;
d) an image region identification information forming unit which is configured to generate computer device identification information which specifies the computer device which outputs the image, and image region identification information which associates said one region in which one or a plurality of images are arranged and the computer device identification information with each other;
e) a pointer image forming unit which is configured to form pointer images which are arranged within the region of said one image;
f) a pointer image position setting unit which is configured to set a position of the pointer image based on the received command signal;
g) a projection unit which is configured to project said one or plurality of images which are synthesized and arranged within the region of said one image, and the pointer image which is set at the position;
h) a computer device specifying unit which is configured to specify the computer device which outputs an image pointed out by the pointer image from the projection position of the pointer image set at the position and the image region identification information; and
i) a transmitting unit which is configured to transmit a specified command signal corresponding to the set projection position of the pointer image to the specified computer device based on the received command signal of the input device.
